(19) United States
(12) Patent Application Publication
(10) Pub. No.: US 2014/0258161 A1
(43) Pub. Date: Sep. 11, 2014

(54) SYSTEMS AND METHODS FOR CAREER INFORMATION PROCESSING

(71) Applicant: Work 4 Labs, Inc., San Francisco, CA (US)

(72) Inventors: Matthew Brown, San Francisco, CA (US); Stephane Le Viet, San Francisco, CA (US)

(21) Appl. No.: 14/195,672

(22) Filed: Mar. 3, 2014

Related U.S. Application Data
(60) Provisional application No. 61/773,697, filed on Mar. 6, 2013.
(60) Provisional application No. 61/785,573, filed on Mar. 14, 2013.
(60) Provisional application No. 61/773,700, filed on Mar. 6, 2013.
(60) Provisional application No. 61/800,859, filed on Mar. 15, 2013.
(60) Provisional application No. 61/825,461, filed on May 20, 2013.

(51) Int. Cl. G06Q 10/10

(52) U.S. Cl. CPC G06Q 10/1053
USPC 705/321

(57) ABSTRACT

Systems and methods for consolidating, preparing, and distributing job information as well as applicant responses are provided. Some embodiments consolidate social profile information to facilitate job applications with minimal candidate involvement. Some embodiments provide systems and methods for assessing an employer's recruitment effectiveness via website analysis. Some embodiments distribute job notifications via participating recruiter social networks. Some embodiments consolidate job information into an accessible “job card” format, facilitating quick assessment by a candidate.

### CROSS-REFERENCE TO RELATED APPLICATIONS

This application claims the benefit and is a nonprovisional application of: U.S. Provisional Application 61/773,697, entitled “1-CLICK-APPLY” (Applicant Reference LABS.0002PR), filed Mar. 6, 2013; U.S. Provisional Application 61/785,573, entitled “1-CLICK-APPLY” (Applicant Reference LABS.0002PR-2), filed Mar. 14, 2013; U.S. Provisional Application 61/773,700, entitled “JOB CARD” (Applicant Reference LABS.0003PR), filed Mar. 6, 2013; U.S. Provisional Application 61/800,859, entitled “SOCIAL JOB SHARING” (Applicant Reference LABS.0004PR), filed Mar. 15, 2013; and U.S. Provisional Application 61/825,461, entitled “SOCIAL RECRUITING SCORE” (Applicant Reference LABS.0005PR), filed May 20, 2013. Each of these applications is incorporated by reference herein in their entirety for all purposes.

### TECHNICAL FIELD

Various of the disclosed embodiments relate to the dissemination, collation, and collection of employment information.

### BACKGROUND

The Internet and social network environment have greatly accelerated the pace at which information is distributed as well as the manner of its distribution. These changes have been particularly pronounced in the workplace, especially in regard to the distribution of employment information and the selection of potential employees. Social networks not only allow a wider pool of applicants to be informed of an open position, but also allow the applicant to be informed of a wider pool of positions. However, matching an applicant with a position remains a difficult problem. Particularly, acquiring the relevant information and identifying correlations between the applicants and positions is nontrivial. Positions are not always presented in a manner which elicits the desired information from the applicant. Conversely, applicants are not always able to discern what information is desired regarding their past experience or the best manner for presenting that information.

Accordingly, there exists a need for systems and methods to facilitate quick and effective presentation, retrieval, and analysis of applicant and employment information.

### BRIEF DESCRIPTION OF THE DRAWINGS

The techniques introduced here may be better understood by referring to the following Detailed Description in conjunction with the accompanying drawings, in which like reference numerals indicate identical or functionally similar elements:

FIG. 1 is an overview block diagram of a network relationship between various entities, such as an employment candidates and an employer (e.g., a human resources manager) as may occur in some embodiments.

FIG. 2 is a flow diagram depicting various aspects of a one click application process as implemented in some embodiments.

FIG. 3 is a screenshot of a portion of a Graphical-User-Interface (GUI) for a one-click application as may be used in some embodiments.

FIG. 4 is a screenshot of an error-correction GUI for a one-click application as may be used in some embodiments.

FIG. 5 is a screenshot of a success dialog box for a one-click application as may be used in some embodiments.

FIG. 6 is a screenshot of a success email for a one-click application as may be used in some embodiments.

FIG. 7 is a screenshot for a returning candidate screen for a one-click application as may be used in some embodiments.

FIG. 8 is a screenshot for an “apply for” screen for a one-click application as may be used in some embodiments.

FIG. 9 is a screenshot for an “apply with social” dialog box for a one-click application as may be used in some embodiments.

FIG. 10 is a screenshot for a “privacy permission” dialog box for a one-click application as may be used in some embodiments.

FIG. 11 is a screenshot of a user social profile for a one-click application as may be used in some embodiments.

FIG. 12 is a high-level block diagram depicting the extraction and insertion of applicant information for a one-click application as may be used in some embodiments.

FIG. 13 is a screenshot of a user social one-click application summary as may be used in some embodiments.

FIG. 14 is a screenshot of an explanatory blurb for a social career site in a one-click application as may be used in some embodiments.

FIG. 15 is a flow diagram depicting certain operations in a social recruitment score determination as may be performed in some embodiments.

FIG. 16 depicts several example metrics that may be used to assess a website's recruitment effect in some embodiments.

FIG. 17 is a block diagram depicting various component inputs and outputs to a social recruiting score application processing module in a social recruitment operation as may be performed in some embodiments.

FIG. 18 is a flow diagram depicting certain technical operations in a social recruitment score determination as may be performed in some embodiments.

FIG. 19 is a high level block diagram of a social recruitment score determination as may occur in some embodiments.

FIG. 20 is a screenshot of a submission portal for a social recruiting score system as may be presented to a user in some embodiments.

FIG. 21 is a screenshot of a mobile application acquisition screen for a social recruiting score system as may be presented to a user in some embodiments.

FIG. 22 is a screenshot of a statistical summary screen of social network data (e.g., Linked In® data) for a social recruiting score system as may be presented to a user in some embodiments.

FIG. 23 is a screenshot of a statistical summary screen of social network data (e.g., Facebook® data) for a social recruiting score system as may be presented to a user in some embodiments.

FIG. 24 is a screenshot of a statistical summary screen of social network messaging data (e.g., Twitter® data) for a social recruiting score system as may be presented to a user in some embodiments.

FIG. 25 is a data flow diagram as may be used in a social recruiting score system in some embodiments.

FIG. 26 is a screenshot of a social recruiting score summary screen for a social recruiting score system as may be presented to a user in some embodiments.

FIG. 27 is a flow diagram depicting various aspects of a system setup for a job system operation as may be implemented in some embodiments.

FIG. 28 is a flow diagram depicting various aspects of a user setup for a job system operation as may be implemented in some embodiments.

FIG. 29 is a high level block diagram of a social job system as may be implemented in some embodiments.

FIG. 30 is a high level block diagram of a user-level overview in a social job system as may be implemented in some embodiments.

FIG. 31 is an example “job card” as may be implemented in some embodiments.

FIG. 32 is a flow diagram depicting certain operations in a job card operation as may be implemented in some embodiments.

FIG. 33 is a high level block diagram of a user-level overview in a job card system as may be implemented in some embodiments.

FIG. 34 is a block diagram of a computer system as may be used to implement features of some of the embodiments.

The headings provided herein are for convenience only and do not necessarily affect the scope or meaning of the claimed embodiments. Further, the drawings have not necessarily been drawn to scale. For example, the dimensions of some of the elements in the figures may be expanded or reduced to help improve the understanding of the embodiments. Similarly, some components and/or operations may be separated into different blocks or combined into a single block for the purposes of discussion of some of the embodiments. Moreover, while the various embodiments are amenable to various modifications and alternative forms, specific embodiments have been shown by way of example in the drawings and are described in detail below. The intention, however, is not to limit the particular embodiments described. On the contrary, the embodiments are intended to cover all modifications, equivalents, and alternatives falling within the scope of the disclosed embodiments as defined by the appended claims.

### DETAILED DESCRIPTION

### General Description

Various examples of the disclosed techniques will now be described in further detail. The following description provides specific details for a thorough understanding and enabling description of these examples. One skilled in the relevant art will understand, however, that the techniques discussed herein may be practiced without many of these details. Likewise, one skilled in the relevant art will also understand that the techniques can include many other obvious features not described in detail herein. Additionally, some well-known structures or functions may not be shown or described in detail below, so as to avoid unnecessarily obscuring the relevant description.

The terminology used below is to be interpreted in its broadest reasonable manner, even though it is being used in conjunction with a detailed description of certain specific examples of the embodiments. Indeed, certain terms may even be emphasized below; however, any terminology intended to be interpreted in any restricted manner will be overtly and specifically defined as such in this section.

### Overview

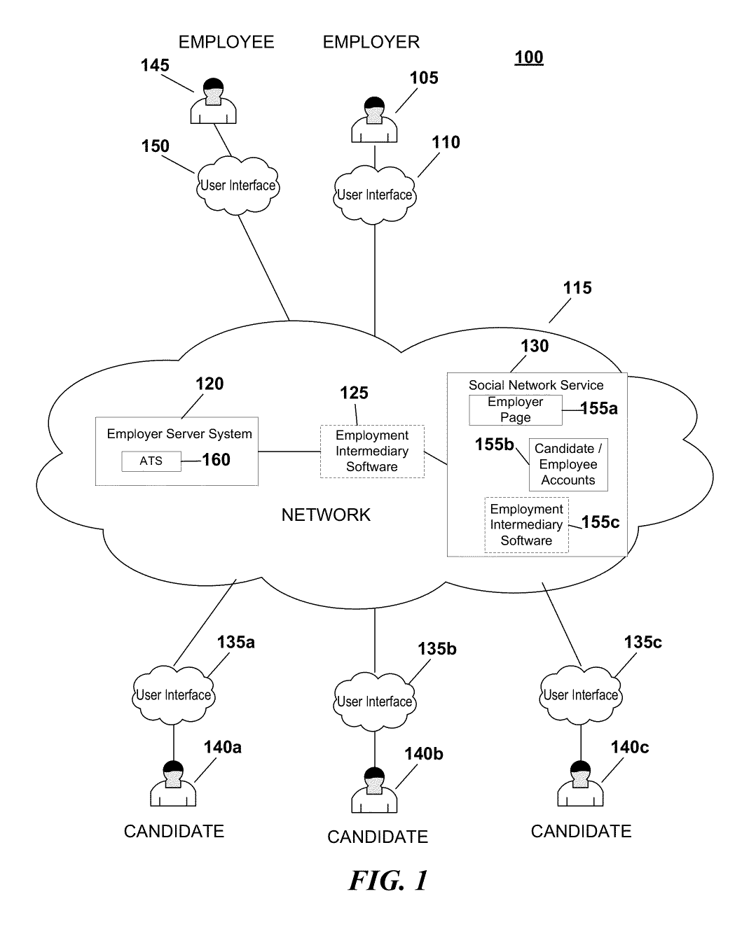

FIG. 1 is an overview block diagram 100 of a network relationship between various entities, such as an employment candidates 140a-c and an employer 105 (e.g., a human resources manager) as may occur in some embodiments. An employer 105 may interface with a network 115, such as the Internet, using an interface 110, e.g., a personal computer, cellular phone, etc. The employer may maintain a network system 120 focused upon the employer's business, but may also maintain a page 155a in a social network service system 130, e.g. Facebook®, Google+®, etc. The page 155a may, for example, provide information about the employer's 105 business and may redirect a visitor to the business' webpage on a separate server.

Candidates 140a-c who may or may not be part of the employer's 105 organization, may also access the network 115 via interfaces 135a-c. Each candidate 140a-c may maintain a personal profile account 155b on social network system 130. An employee 145 of employer 105 may also be in communication with the network 115 and may be a member of various social networks, including social network service 130. Employee 145 may also have an account 155b on the system 130. Employee 145 and candidate 140b, for example, may be casual friends or members of some social group unrelated to the employer's 105 business. For example, both employee 145 and candidate 140b may be members of a software special interest group.

Various embodiments contemplate intermediary software 125 and intermediary employment software 155c which may serve to retrieve, collate, and analyze social information so that appropriate candidates 140a-c can be identified for various open positions in employer's 105 organization. Intermediary employment software 155c may also exist on the social system 130, e.g., as plugins or software libraries incorporated into the accounts 155b or pages 155a of the social network system 130. Network system 120 may include an Applicant Tracking System (ATS) 160 used to consolidate information regarding applications for various positions. In some embodiments, the ATS may simply be a server prepared by the employer 105 to consolidate employment information while in some embodiments the ATS server may be a third party system operated on behalf of the employer 105.

As discussed in greater detail below, the intermediary software 125, 155c may consolidate candidate information, e.g., with reference to the social relations between the employee, candidate, and other social network members and personal information from a candidate's social profile. The intermediary software 125, 155c may provide the information to the ATS for analysis and consideration by the employer 105.

### One-Click Apply

Various embodiments contemplate a “One Click Apply” system which allows job seekers to use at least a portion of their social profiles (e.g., Facebook®) to complete job application forms. The fields used in ‘One Click Apply’ may include, e.g.: Name; Email Address; Current City and/or ZIP Code; Work History (Company, Title, Tenure); Education {School, Concentration, Degree, Graduation). However, in some embodiments ‘One Click Apply’ can adapt to any data available in the profile and/or required in the job application, including birthdate, languages spoken, skills and certifications, etc. Some embodiments of the “One Click Apply” system may be implemented as plug-in intermediary components 155c to a social networking site.

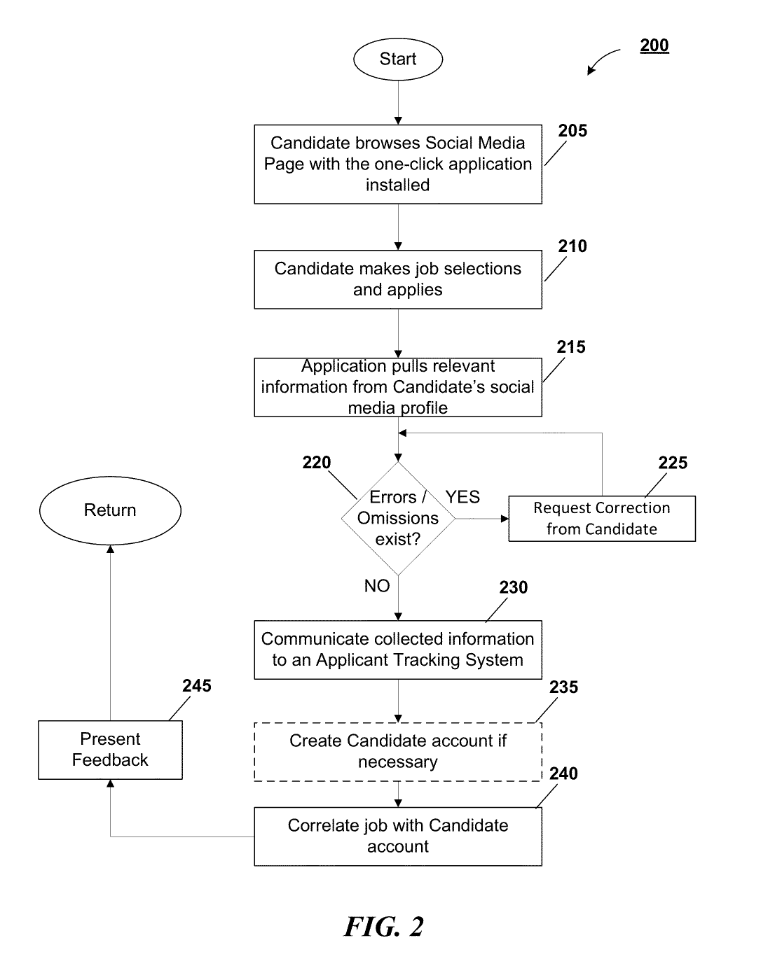

FIG. 2 is a flow diagram depicting various aspects of a one click application process 200 as implemented in some embodiments. At block 205 a candidate may browse a social page wherein the one-click functionality is available (e.g., the employer's page 155a, or the employer's business website in communication with a social network API). The functionality may be provided as a plug-in or as an API to a social network site or to a stand-alone webserver.

At block 210 the candidate may make job selections via an interface on the webpage. For example, the candidate may select the jobs to be applied to from a list on the webpage. In some embodiments, the candidate may specify desired working hours, past experiences, preferred location, etc. as part of the selection, e.g., as when the list of jobs includes different selections each indicating variations in the application parameters. At block 215 the system (e.g., intermediary software 155c or 125) may pull the relevant application information for each job selection from the candidate's social profile. For example, candidate location, past work history, educational history, headlines, languages, likes (e.g., metadata associated with content on a social network, such as Facebook®), experience level, etc. may be pulled from their social profile using, e.g., a social network API. The information may be pulled first by asking the candidate for permission to access the candidate's profile on the social network. Following the candidate's acceptance, the application may connect to the social network's API with the correct authorization token (e.g., as provided by the candidate) to acquire the candidate information. The social profile data may include data originally submitted by the candidate, as well as data automatically determined or generated by the social network site (e.g., statistics regarding the candidate's interactions with other social network members, number of visits to an interest group webpage, etc.). For example, the social profile data may include an “experience level” requested by the ATS, but not available on the social network. Instead, the “experience level” may, e.g., be automatically calculated based upon the candidate's age as indicated in the social network profile.

At block 220, the system may identify errors and omissions in the collected social profile data. This error identification may occur substantially in real-time in some embodiments, while the candidate data is being pulled automatically from the social profile or as the candidate manually inserts data into the application form. For example, the candidate's social network profile may lack all the necessary information for completing an application action, or the social information may be inconsistent with other available information, e.g., as determined by a series of rules. That is, the application form may require a password with a minimum of 8 digits and the candidate only inserts 5 digits. As another example, the phone number format may require an international format with country code “+1 515-989-4343” but the candidate social profile may include a phone number without Country code “515-989-4343.

If errors or omissions exist, at block 225 the system may request correction from the candidate, or seek internal automated tools to perform the correction (e.g., insertion of dummy values, or determination of the correct value by referencing other corresponding data). For example, if the country code from the phone number is missing, the system may locate the mapping code in a mapping table from the country of the candidate social profile and append the mapping code to the phone number retrieved from the candidate social profile. At block 230, if all or a sufficient number of errors/omissions have been resolved, the system may communicate the collected information to an ATS, e.g., as monitored by an employer. In some embodiments, if some of the information cannot be sent to the ATS in real time, the application may send an email to the candidate, or otherwise allow the candidate to proceed with the application at a later time.

In some embodiments, candidate information may be transmitted to the ATS in a three step process. The steps are generally referred to herein as “Account Creation”, “User Information”, and “Application Start”. During Account Creation in some embodiments the system may send an email (or other indication of user identity) and password to the ATS. During User Information, the system may send user data, e.g. the candidate's last name, first name, address, and phone number to the ATS. During “Application Start” the system may send employment-related data, e.g., a cover letter file, resume file, education history, and employment history. Separating the delivery of information in this manner may also facilitate recovery in the event of failure, or if the candidate should decide to defer completion of the application process.

At block 235, if an account does not exist for this candidate on the ATS, the system may create one. For example, the ATS may be run by a third-party separate from the employer, and may implement general purpose profiles beyond the needs of the employer. The system (again, e.g., either intermediary software 155c or 125) may be configured to adapt the information as specified by the employer for the ATS system. The software intermediary may be configured such that each and every data field collected in the candidate social media profile can be sent to the corresponding field in the employer's system (for example the Phone Number will be mapped to “Home Phone” if “Phone Number” as such is not present). In some embodiments, two different techniques may be used by the application in order to send the information to the ATS. The first “skinning” technique mimics a human being on a browser via back end software (e.g., submitting GET and POST requests as a human operator would). In the second “API” technique the application connects directly to the ATS system through the ATS API (e.g., delivering packets directly to a socket interface anticipating a particular data format). At block 240, the system may correlate the job application with the candidate's account and populate any remaining fields in the application.

At block 245, the system may present feedback to the candidate and/or to an employer. For example, the system may notify the candidate of the creation of the profile, adjustments to the application contents, substitutions for omissions, etc. The employer may be informed of recurring omissions related to their request format, adjustments for improving the receipt of applications, etc. In this manner the intermediate software may be reconfigured and adjusted iteratively (automatically or by hand) to improve performance. In some embodiments, the feedback may occur through the social media platform, or through an email or any other communication system.

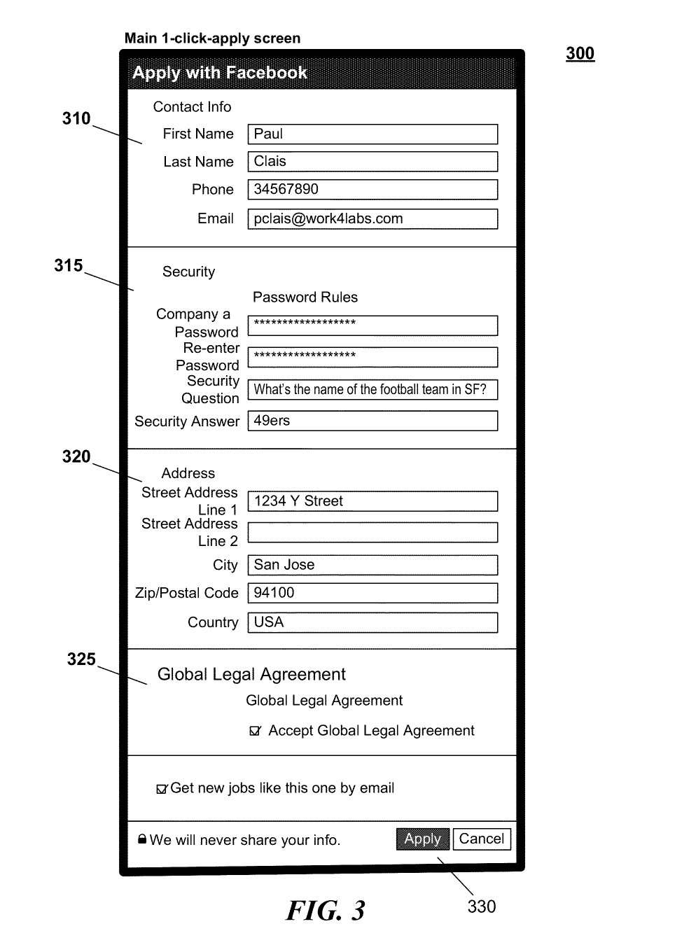

FIG. 3 is a screenshot of a portion of a GUI 300 for a one-click application as may be used in some embodiments. GUI 300 may be presented, e.g., on social network page 155a. Region 310 depicts entries for receiving the candidate's name and contact information. In some embodiments this information may instead be automatically scraped from the candidate's social profile or may be confirmed with reference to the social profile. This information may be directly transmitted to the ATS, or used to first populate the fields in region 310. Region 315 depicts entries for receiving security information from the candidate, such as a password and security question. In some embodiments, these values are reused for subsequent applications, removing the need for repetitious entries. Region 320 depicts an address region. This information may also be retrieved from the candidate's social profile or may be confirmed with reference to the social profile. However, in instances where the job may require relocation, the region may be used by the candidate to specify a plurality of acceptable relocations. Region 325 depicts a form for acceptance of global legal agreement. Acceptance of the agreement may facilitate reuse of several of the inputted entries in subsequent applications. Input 330 may be used to submit the form following completion. The GUI is properly filled, either manually by the candidate or automatically by the system. The GUI may be filled automatically based upon the amount of information on the social media profile of the candidate and the candidate's permitting the system to retrieve information from the social media profile. In some embodiments, the candidate can review the information and modify it before clicking the apply button.

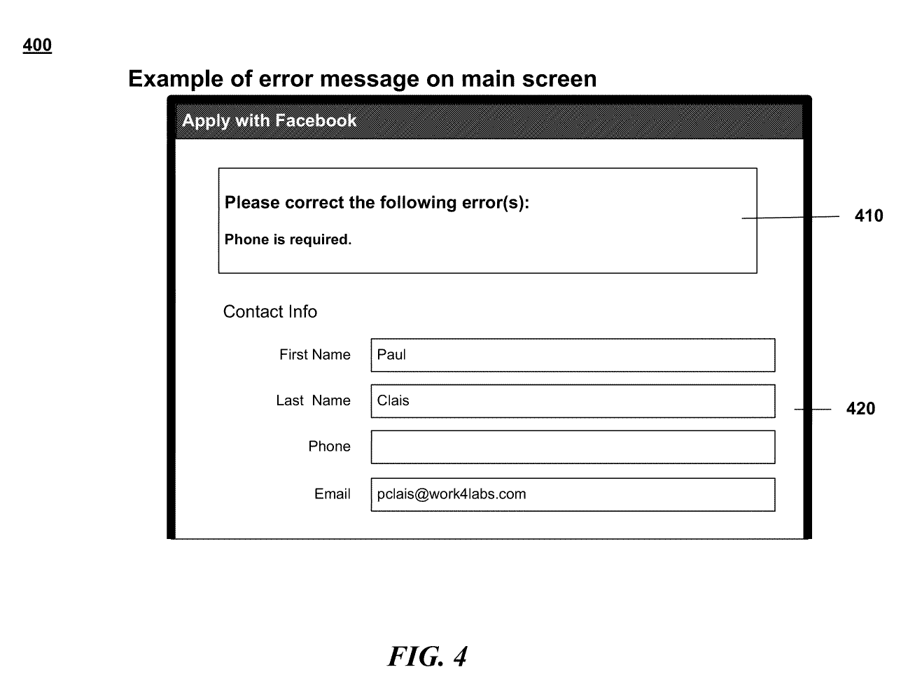

FIG. 4 is a screenshot of an error-correction GUI 400 for a one-click application as may be used in some embodiments. The error-correction GUI 400 may be presented, e.g., at block 225 when requesting corrections from the candidate. An indication and/or explanation of the error/omission may be provided at region 410. Corrections or supplemental information may be provided in response region 420. In some embodiments, error-correction GUI 400 may be presented only after the system attempts to correct lacunae or errors in the applicant information. The error-correction GUI 400 may then only present those fields which remain uncorrected but may be required by the ATS.

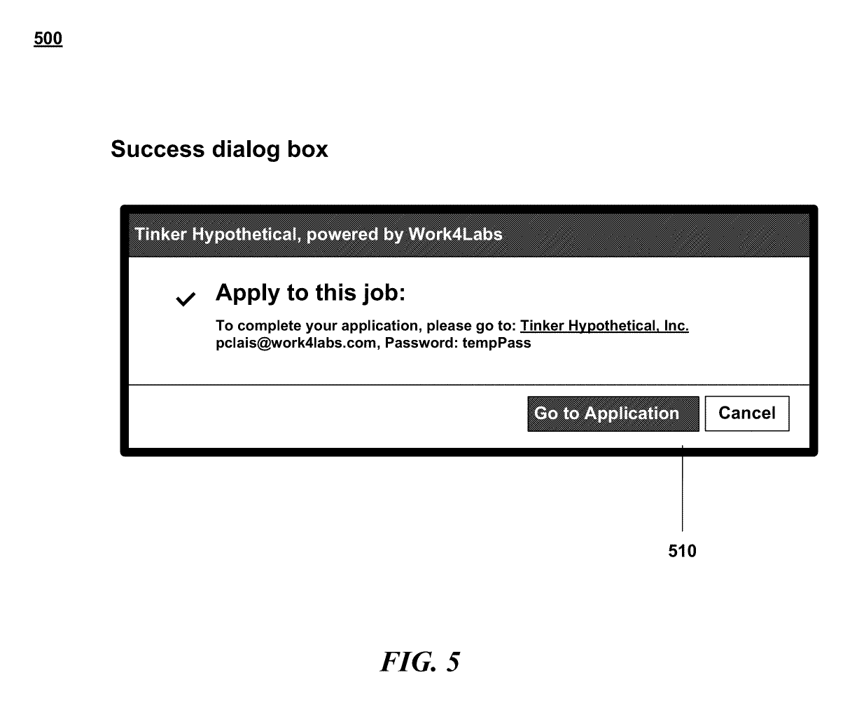

FIG. 5 is a screenshot of a success dialog box 500 for a one-click application as may be used in some embodiments. The candidate may review and accept or reject the prepared application by selecting input 510. In some examples, such as the one depicted, completion of the application may require that the user be redirected to another website, e.g., a website maintained by the employer. For example, the underlined portion “Tinker Hypothetical, Inc.” may be a hyperlink redirecting to the company's application site, with various aspects of the application completed by GET, POST, or cookie variables. In some embodiments, however, dialog box 500 merely presents the user with an opportunity to confirm that they wish to apply before the information is submitted to the ATS.

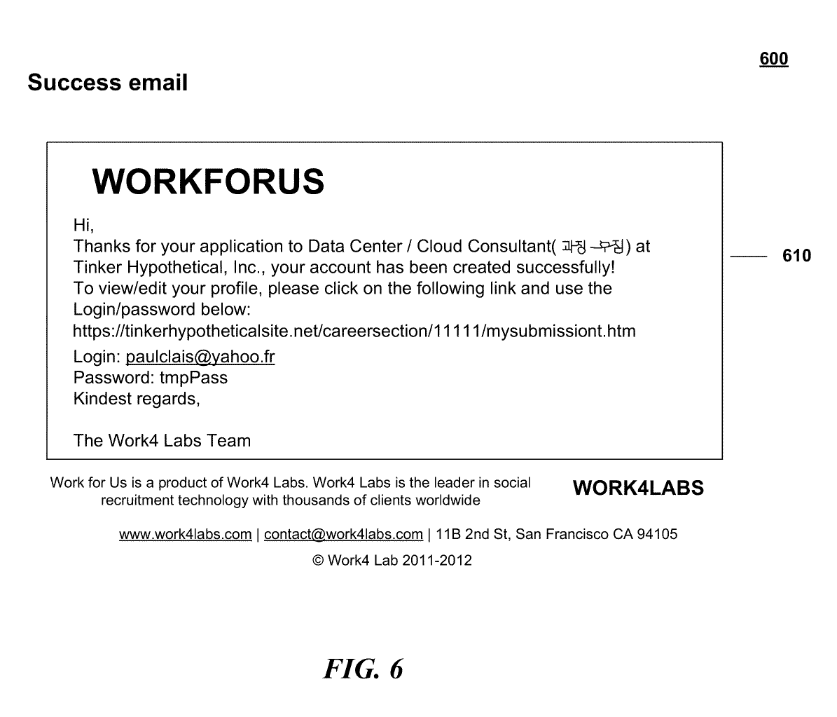

FIG. 6 is a screenshot of a success email 600 for a one-click application as may be used in some embodiments. The user may receive the email at the address specified in their application information or social profile. The email 600 is just one example of the form the feedback (e.g., as provided at block 245) may assume. For example, feedback may additionally or alternatively be displayed after confirmation screen 500. An information region 610 may summarize the status of the application and the character of the received information. Similar messages may be provided via SMS messages, internal messages within the social site to the candidate, etc. In some embodiments, following the initial registration process, the user need only select a single button to subsequently apply to another position.

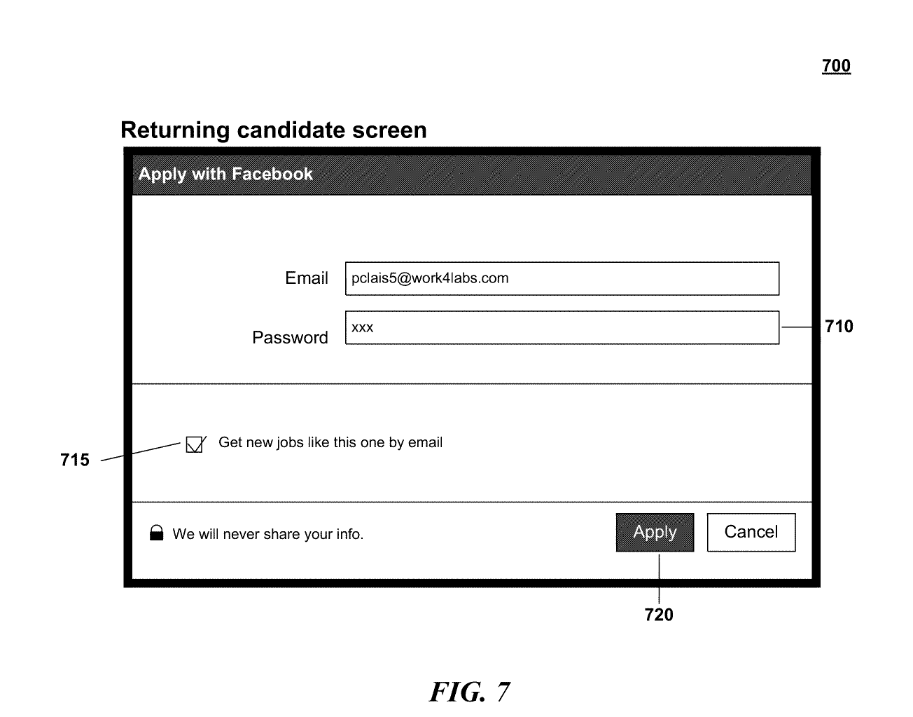

FIG. 7 is a screenshot for a returning candidate screen 700 for a one-click application as may be used in some embodiments. In some embodiments, having once completed the information in screen 300 or indicated that relevant information was to be scraped from their social profile, the candidate need only reenter their password in a confirmation region 710. In some embodiments, such a password login is even unnecessary following the user's logging into the social network site. In these embodiments, selection of a single application button by the user may be all that is necessary to proceed with the application's submission.

In this example, having identified a relevant job (e.g., on another employer's page 155a, or displayed on server 120), the candidate may then apply immediately, e.g., selecting icon 720, without reentering the basic information. The candidate can also indicate whether they wish to receive similar job notifications in the future 715. In some embodiments, the system provides an option to the candidate to again review the information and to make any desired changes before submitting the data. It could be useful, for instance, when first sending a cover letter to a position for the candidate to modify the cover letter for the particular position. Thus, common application information may be reused between applications, while position specific content, such as a cover letter, may be adapted by the user for each application. In some embodiments, if the candidate changes their information on the social media profile, the system may update the application information with the new data.

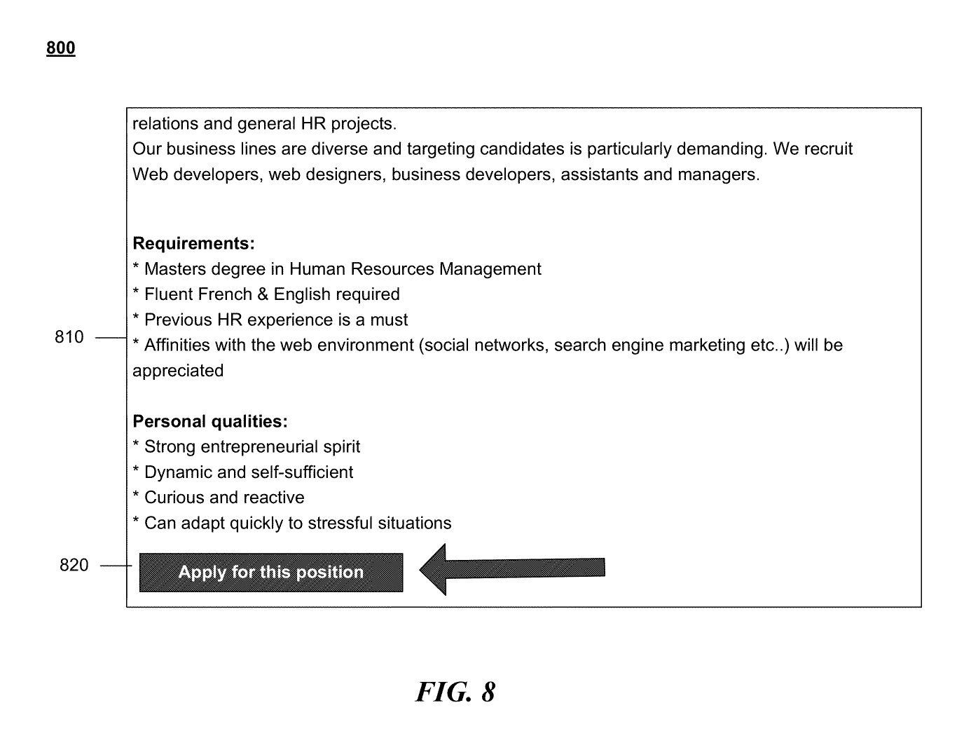

FIG. 8 is a screenshot for an “apply for” screen 800 for a one-click application as may be used in some embodiments. Requirements and candidate qualities specified by the employer may be provided in region 810. Selecting the “apply” input 820 may cause the system to prepare an application based upon previously collected information regarding the candidate and submit the collected information to the appropriate ATS (or to begin the previously described process if this is the first time the applicant has applied through the system). As discussed above, in some embodiments, following the user's logging into the social network, they may be presented with screen 800 and may immediately apply to the position by selecting “apply” input 820.

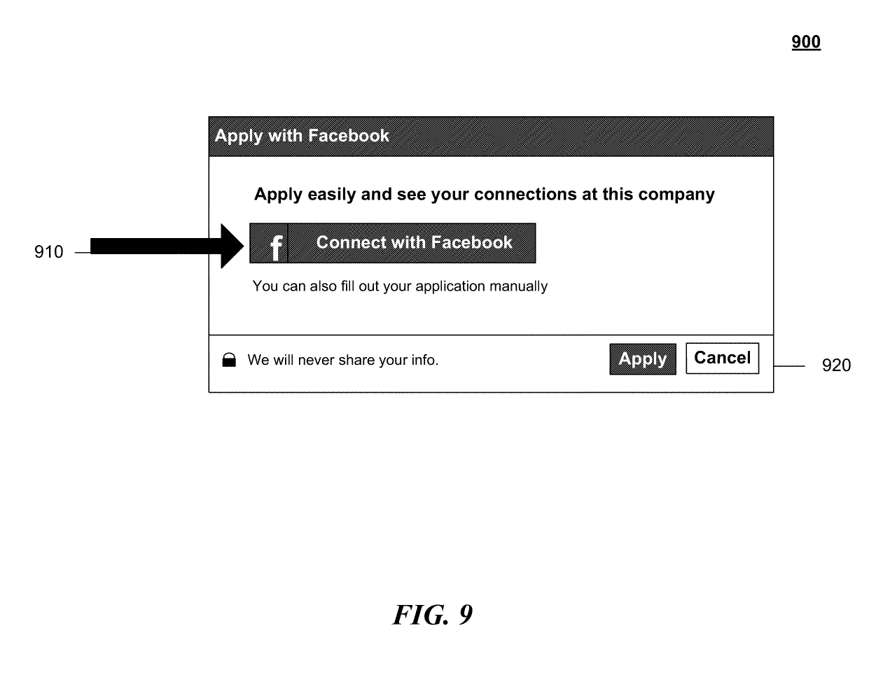

FIG. 9 is a screenshot for an “apply with social” dialog box 900 for a one-click application as may be used in some embodiments. In this example, an input 910 invites the candidate to connect with their social profile to begin an application process. In some embodiments, the dialog box 900 may be presented to the candidate while the candidate visits a non-social site (e.g., the employer's business site 120, or the website of a distributor of the employer's product). Following the candidate's logging into the social network site, they may be presented with “apply for” screen 800 and/or modification pages, e.g., to adjust their cover letter.

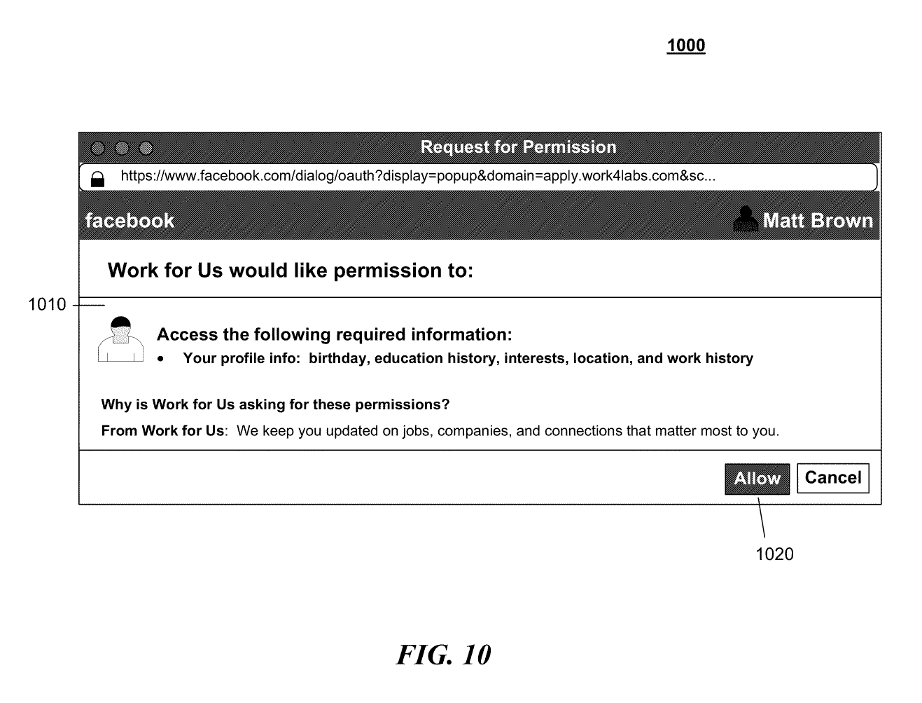

FIG. 10 is a screenshot for a “privacy permission” dialog box 1000 for a one-click application as may be used in some embodiments. In some embodiments, the system may request permission to send private material only once for an entire corpus of applications (including present and future applications). In some embodiments, permission is asked for each application or for subsets of applications, based, e.g., upon the candidate's preferences. A permission access region 1010 may indicate the character of the information to be collected by an employer. In this example, the company “Work for Us” would like to retrieve information regarding the user's profile information. Such a privacy permission dialog can be presented once to the candidate in regard to information to be reused across multiple applications. Alternatively, the dialog may be presented for each successive application in the event the candidate wishes to differentiate applications provided to different employers. In some embodiments, the application data may be saved and made available to other applications configured to improve candidate-position matching as a global problem. In some embodiments the candidate name and email may be anonymized to protect the user's privacy. In some embodiments, candidate passwords are not saved on the application servers more than a fixed period, e.g., 24 hours. In some embodiments, submission of an application may be made public to some or all of the user's peers on the social network. In this manner, peers affiliated with the company to which the application was submitted may be made aware of the candidate's desire for employment and may make recommendations or suggestions to management.

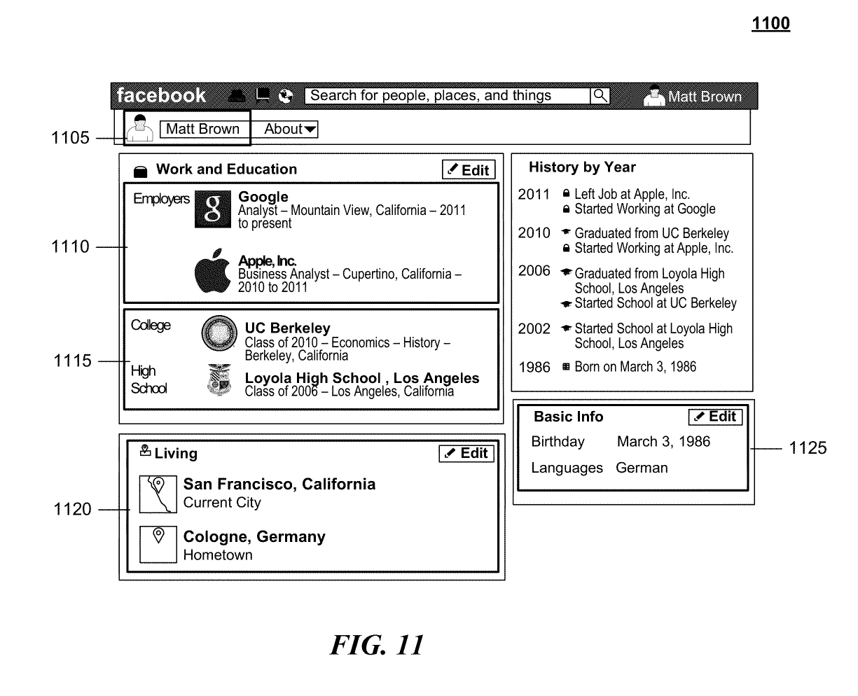

FIG. 11 is a screenshot of a user social profile 1100 for a one-click application as may be used in some embodiments. In this example, the system may collect social information from the candidate's profile and present the information in regions 1105, 1110, 1115, 1120, and 1125, e.g., for the candidate's confirmation. For example, some candidates may have entered false data to the social network to preserve their privacy and may wish to substitute the actual values when submitting their application. The candidate's profile name may be presented in region 1105 and their work and education information in regions 1110 and 1115. Past and present residence information may appear in region 1120 and other basic biographic information in region 1125. Where discrepancies are identified the candidate may selected the “edit” tab and provide corrections.

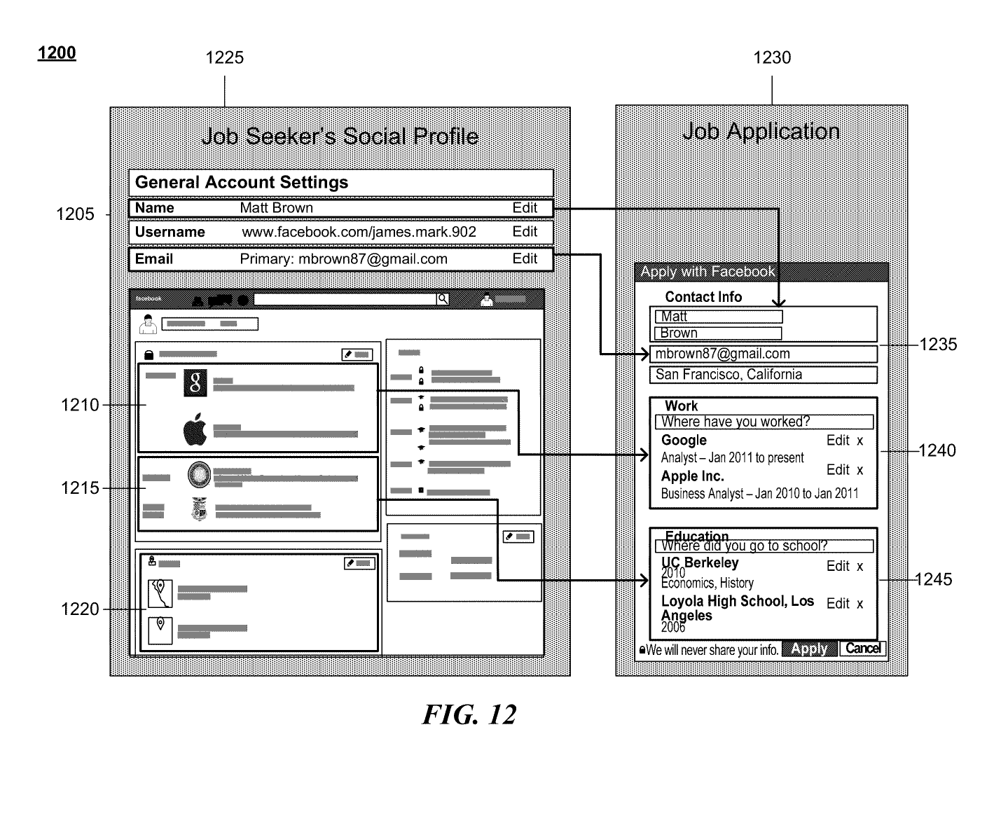

FIG. 12 is a high-level block diagram depicting the extraction and insertion 1200 of applicant information for a one-click application as may be used in some embodiments. In this example, the system may transfer candidate profile information 1225 to a job application 1230, e.g., as anticipated by an ATS. The data may be stored in a relational (SQL) database, JSON document, a document store (NoSQL, Mongo), etc. A document-model based database may be more suitable in some embodiments where there is a one-to-one correspondence between a candidate's information and a candidate document. As depicted, one or more of the regions 1205, 1210, 1215, and 1220 of the social profile depicting identification, work history, education, and location information, respectively, may be mapped to a corresponding input 1235, 1240, and 1245 of the application. The application may use API integration with the social media site to retrieve the candidate information. The application may then save the information into a database, package the data, and send then send the data to the ATS with a skinning or API technique as discussed above.

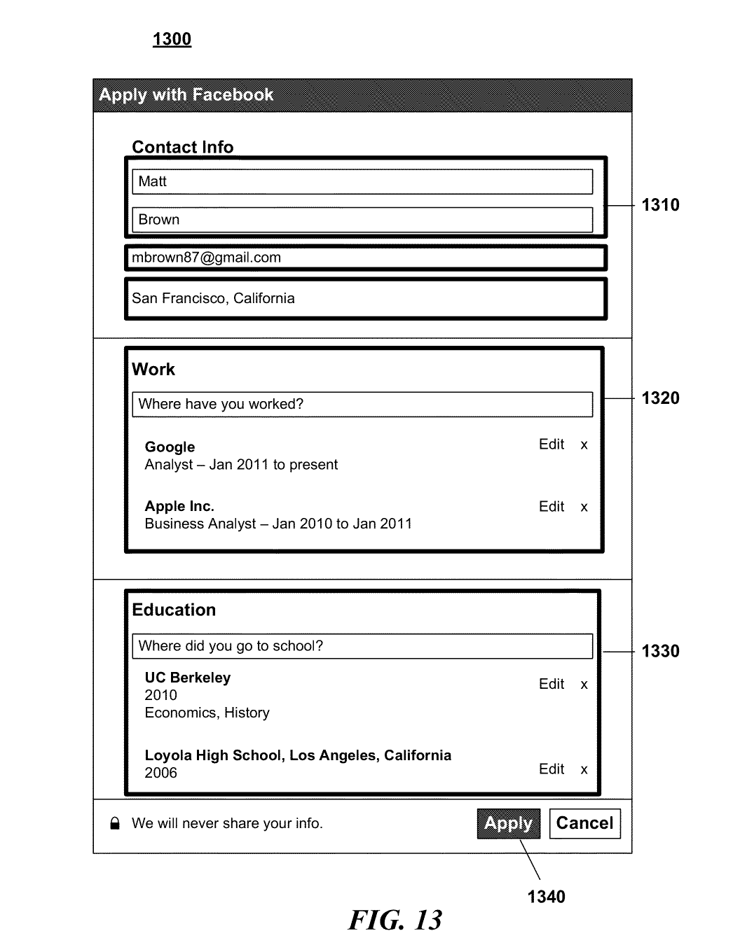

FIG. 13 is a screenshot of a user social one-click application summary 1300 as may be used in some embodiments. Fields for contact information 1310, work history information 1320, and education history 1330, may each be auto-populated based on information scraped from the candidate's social profile and previous inputs upon selection of an accept icon 1340.

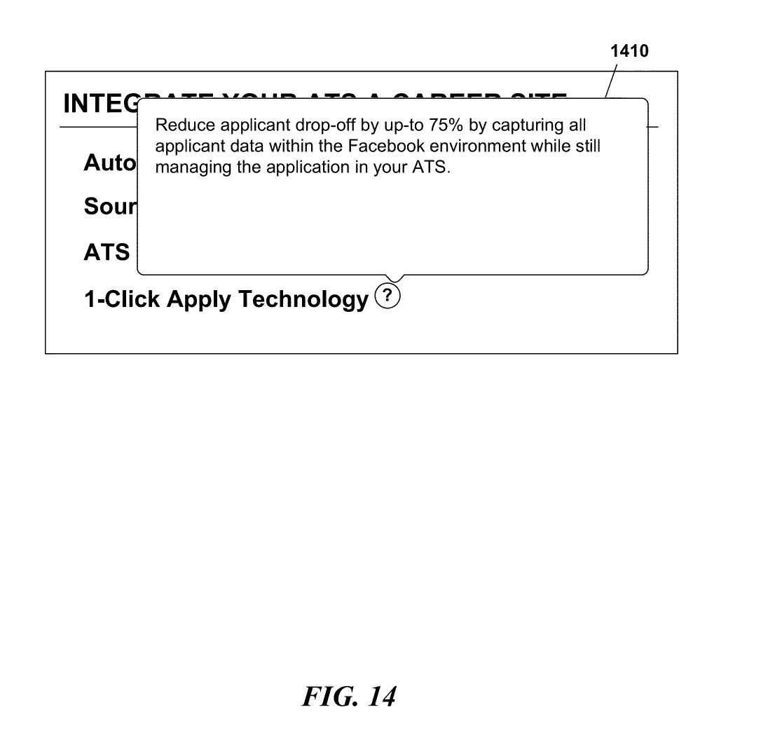

FIG. 14 is a screenshot of an explanatory blurb 1410 for a social career site in a one-click application as may be used in some embodiments. The blurb 1410 may explain the operation of a feature to an employer generating a portion of the application page. Such a blurb may be used to provide feedback at block 245 as previously described. The blurb may help the candidate understand that the system will proceed to create an application directly on the employer's website (e.g., when submitting a form). In this example, the blurb may be presented to an employer rather than a candidate, explaining the benefits of using the one-click system. One will readily recognize that blurbs may instead be provided to the candidate to guide the candidate through the significance of each step in the one-click process. For example, the blurb may make clear that selecting a single button in screen 800 or screen 900 may suffice to submit an application.

### Social Recruiting Score

In some embodiments, employers may be interested in assessing the quality of their business website and/or social network page, e.g., in attracting applicants and/or disseminating employment opportunities. These embodiments may provide an application to, e.g., a human resource manager, employer, website manager, etc. or other user. The software may help the user adjust their website's social footprint to improve recruitment via the social networks channel. For example, the system may apply various metrics to assess the recruitment effectiveness of the existing website on various social networks. The assessment may be presented as a “social recruitment score” reflecting the website's recruiting effectiveness.

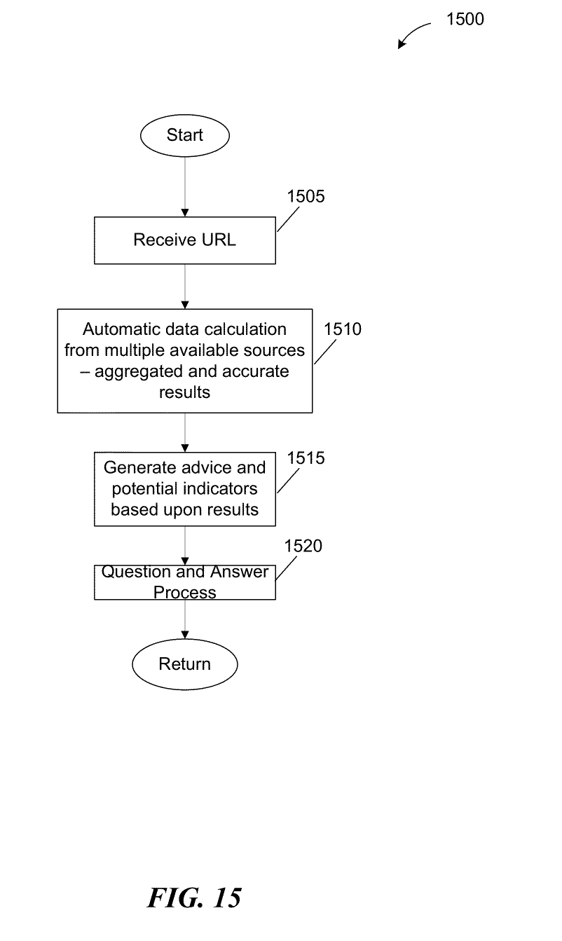

FIG. 15 is a flow diagram depicting certain operations in a social recruitment score determination 1500 as may be performed in some embodiments. A social recruitment application may be a standalone software application running locally on a user device, or may be a website-based system for performing an assessment. At block 1505 the social recruitment application may receive a website address, such as a company career website address, for assessment. The address (e.g., a URL or the company name) may be typed by the user, automatically scraped by a botcrawler, etc.

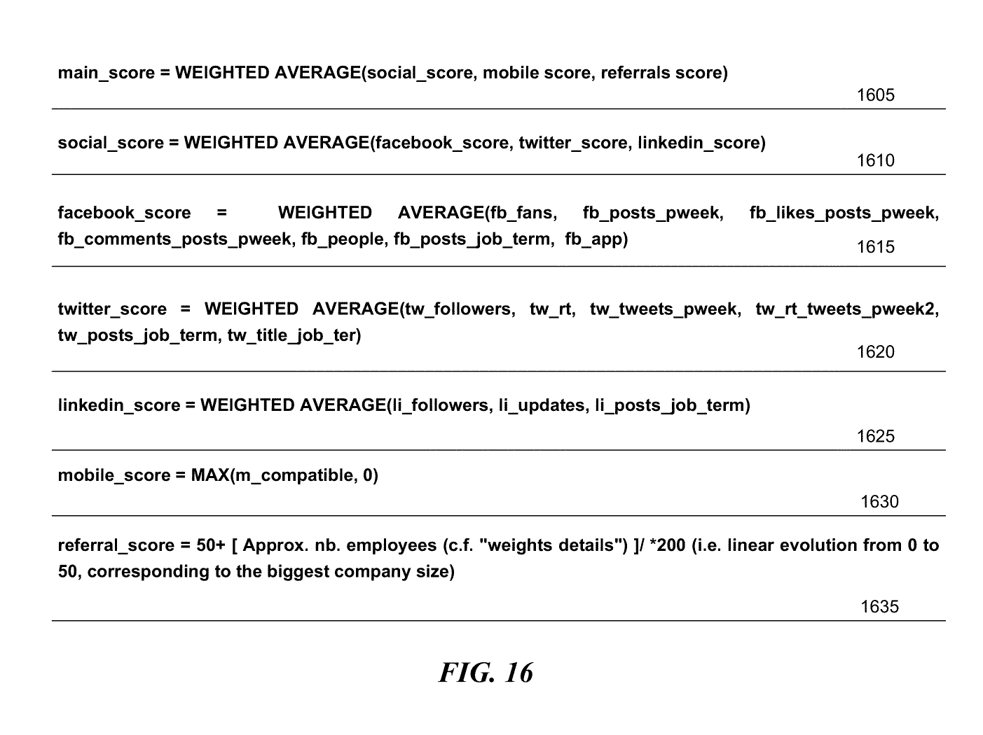

At block 1510 the social recruitment application may automatically calculate metrics assessing the website's recruitment effect. For example, FIG. 16 depicts several example metrics 1605-1635 that may be calculated and used to assess a website's recruitment effect in some embodiments. The “main score metric” 1605 may depict a weighted average of a “social score” 1610 representing the social effect of the site, a “mobile score” 1630 representing the website's mobile capability, and a “referrals score” 1635 representing the employee referral effect. The weights ascribed to each component score may be determined empirically based on a collection of standardized or hypothesized examples.

In this example, the “social score” 1605 may be a weighted average of a social network score, e.g., a “Facebook® score” 1615, a social messaging service score, e.g., a “Twitter® score” 1620, and a business social networking score, e.g., a “LinkedIn® score” 1625. The social network score, e.g., “Facebook® score” 1615 may itself be a weighted average of a number of the site's fans (“fb_fans”), posts to the social network site per week (“fb_posts_pweek”), social network votes, e.g., “likes” for the website per week (“fb_likes_posts_pweek”), comments on the site (“fb_comments_posts_pweek”), social network users associated with the site (“fb_people”), posts on the site related to jobs (“fb_posts_job_term”), and a score value for whether there is a social network application for the site (“fb_app”).

In this example, the social messaging service score, e.g., a “Twitter® score” 1620 may be a weighted average of the number of followers of the website on the social messaging service (“tw_followers”), a number of repetitions of a message (“tw_rt”), a number of messages generated at the site per week (“tw_tweets_pweek”), a number of repetitions (e.g., comments or replies) of a message generated at the site per week (“tw_rt_tweets_pweek2”), messages concerning job posts (“tw_posts_job_term”), and messages regarding job titles (“tw_title_job_ter”).

The business social networking score, e.g., a “LinkedIn® score” 1625 may be a weighted average of the number of followers of the website on a business social networking service (“li_followers”), the number of updates on the site (“li_updates”), a number of posts concerning a job (“li_postsjob_term”).

The “mobile score” 1630 may be a measure of the maximum number of compatible mobile devices under the website's current configuration.

The “referral_score” 1635 may be based on the size of the company or its affiliates associated with the website and the consequent number of potential referring entities. For example, the score may depict the approximate number of employees in the company relative to a maximum number of possible employees (e.g., 200), weighted to a scaling value (e.g., 50). In some embodiments, more employees in a company is believed to imply a larger potential referral network. The metrics of FIG. 16, are merely examples, and one will readily recognize variations beyond those described here. Each of the variables (both the component variables and the combined results) discussed above may be weighted and/or normalized based, e.g., on previous empirical observations.

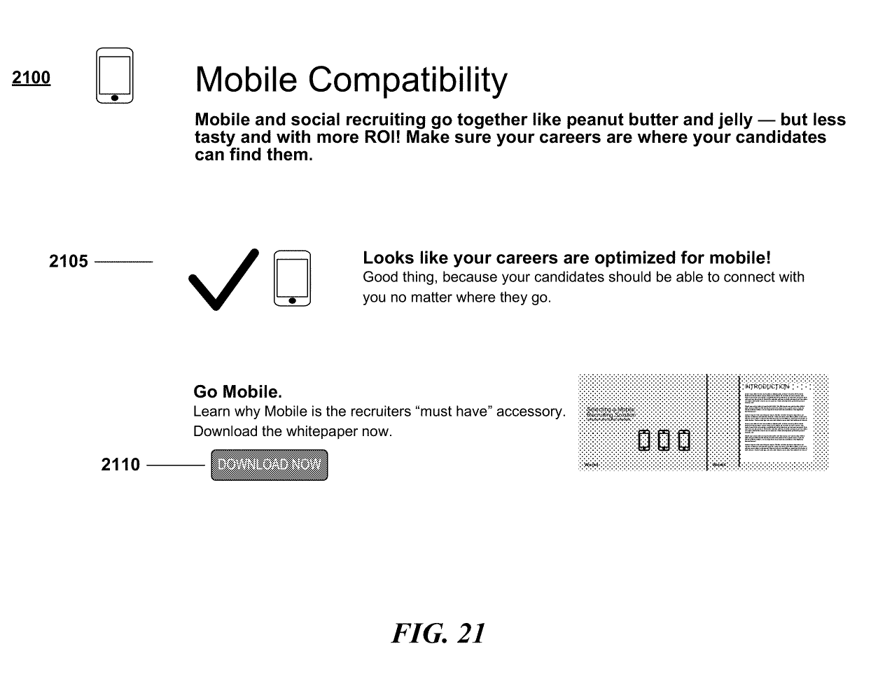

Returning to the flow diagram of FIG. 15, at block 1515 the social recruiting score application may provide advice and various indicators of the submitted website's performance, e.g., in the form of graphs or tabular summaries, to the user (e.g., summary screens such as those discussed herein with reference to FIG. 21-24).

At block 1520 the social recruitment application may perform a question and answer process with the user to help identify measures for improving the submitted website's ability to attract and retain applicants. In some embodiments, the application may identify components of the main score that could be improved. For example, the social recruiting score application may suggest adding more users to the social network page of the company, encouraging more activity on the company page, or suggesting that the company website be made more compatible with certain mobile and other devices. An example question may be: “We couldn't find a mobile compatible website, would you like to learn more about our solutions for acquiring more mobile candidates?” Thus, the social recruiting score application may not only identify deficient areas in the target website, but based upon the component scoring architecture, may be able to identify the reasons for the deficient behavior and to offer solutions.

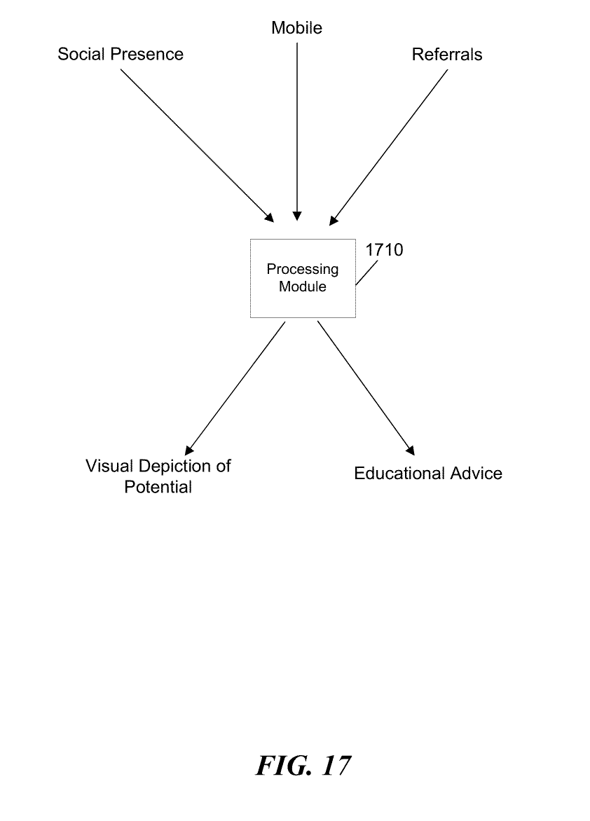

FIG. 17 is a block diagram depicting various component inputs and outputs to a social recruiting score application processing module 1710 in a social recruitment operation as may be performed in some embodiments. Each of social presence, mobile, or referrals information may be provided to a processing module in the social recruitment application or may be calculated based on assessments of the submitted website. In response to these inputs, the processing module 1710 may provide a visual depiction of the website's potential, e.g., in the form of a pie chart with scores for each component such as social presence, mobile potential, referrals potential, as well as pertinent educational advice, like “you should really try to have a mobile friendly website in order to attract more candidates”.

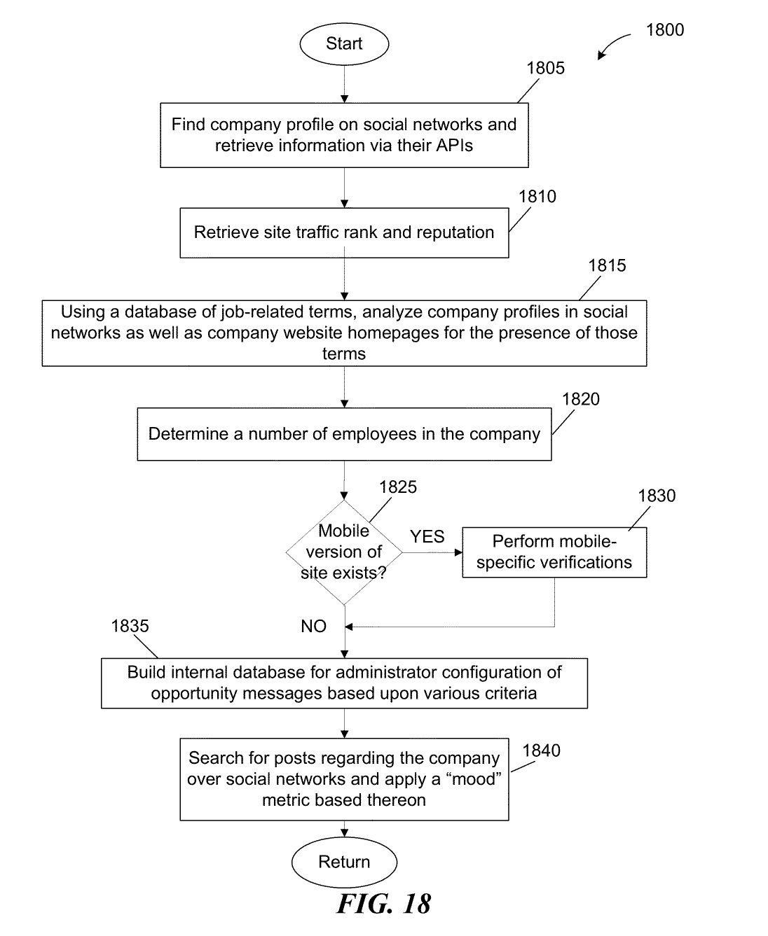

FIG. 18 is a flow diagram depicting certain technical operations in a social recruitment score determination 1800 as may be performed in some embodiments, e.g., within processing module 1710. These operations may be performed on a local user machine, or may be initiated on one or more servers via a web interface in some embodiments. At block 1805 the system may locate a company's profile on a social network and retrieve various information (e.g., number of followers/subscribers). This retrieval may be in response to a user's submission of the company name or company URL on a screen, e.g., screen submission portal 2000. The information may be retrieved used social plugins and APIs available at the site, by user input, or in some embodiments using general web crawling procedures. For example, where the user submits the company name “Bob's Car Repair”, the crawlers may locate the company website for “Bob's Car Repair” as well as the Facebook® profile page for “Bob's Car Repair”.

At block 1810 the system may retrieve site traffic rank and reputation information, e.g. using the Alexa® ranking service or a service similar thereto.

At block 1815 the system may consult a database of job-related terms. The system may analyze company profiles from social networks as well as company website homepages to determine the presence of various terms from the database. For example, the job-related terms may indicate that the website is appropriately calling candidate attention to certain openings. Lack of the terms may suggest that the website is improperly configured to attract candidates.

At block 1820 the system may determine the number of company employees, e.g., using the Linked-In® API, the number of followers of the company using the Linked-In® API, the number of fans of the company using the Facebook® API, or any other relevant information linked to the company social presence with the use of the social networks APIs.

At block 1825 the system may determine if a mobile version of the company's website exists. If so, the mobile-specific verifications may be performed at block 1830 (in the absence of a mobile version, no-score or a negative score value may be attributed in some embodiments). In some embodiments, a website may be considered to be mobile compatible if it serves a different page to Desktop users than it serves to Mobile users, or if the Mobile page contains a meta “viewport” tag (indicating that they are most likely trying to serve a responsive design site). The system may load the page as if from a mobile device (e.g., providing header information so as to impersonate a mobile device) and consider the returned page's contents. In some embodiments, the system may first ensure that those contents correspond to a careers page (a non-careers page can be returned on mobile if the home page is systematically served, for instance). If a careers page is not returned, the page may be determined to be incompatible for mobile devices.

If a careers page is returned, the system may check for the presence of HTML tags that are generally only useful and used on mobile, which if present, may reveal that the page's developers have made sure it is mobile compatible. If the system does not identify such tags, the system may load the page as if from a desktop browser, and if the contents returned are sufficiently different from the mobile version, the system may still determine that the developers of the page have adjusted the page's mobile version. The mere existence of different pages for mobile and desktop users may receive a lower compatibility valuation than a mobile version providing mobile-specific tags (but perhaps a higher valuation than when there is no difference at all). In some embodiments, the system may also check if the page has implemented JavaScript functionality provided to ensure mobile compatibility on the careers page. The functionality may be provided by the administrator of the system performing the analysis.

At block 1835 the system may construct an internal database of information for use by an administrator to construct “opportunity messages” based upon various criteria, e.g., the different scores regarding each components. An opportunity message may indicate that a component score may be significantly increased by taking specific actions such as purchasing related products provided by the system manager, building a fan base on Facebook®, create a more mobile friendly website, etc. Thus the database may provide tailored solutions based on various collections of component values. More than one solution may be offered if more than one component value is delinquent, and different solutions may be presented if various combinations of component values are or are not delinquent.

At block 1840 the system may search for posts on social sites regarding the company and determine the public “mood” regarding the company. For example, keyword searches may be performed wherein inflammatory or critical language is identified regarding the website and/or the company. The appearance of the company's name on websites associated with inflammatory or damaging discussions may also be taken into consideration. Where sites provide ratings, e.g. regarding customer satisfaction, the ratings may also be incorporated. The various data points may be weighted based upon their reliability, relevance, etc. to create a cumulative determination of the company's public perception. Various of the information collected in process 1800 may then be used to present analysis results to a user.

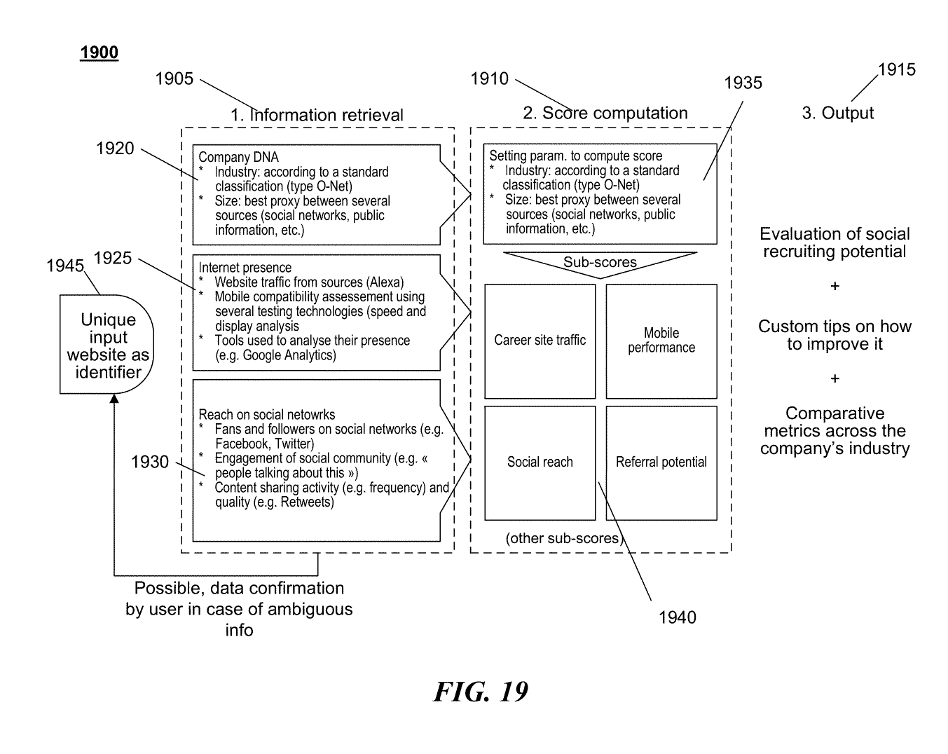

FIG. 19 is a high level block diagram of a social recruitment score determination 1900 as may occur in some embodiments. Generally, as discussed in relation to FIG. 15, the system may retrieve information 1905 concerning a website, analyze the information 1910, and output 1915 a result. Information retrieval may be executed following receipt of a unique identifier 1945 associated with the site to be analyzed.

As indicated, information retrieval 1905 may include, e.g., company “DNA” 1920, company Internet presence 1925, and social network influence 1930. Company “DNA” 1920 may include publicly available information regarding the character (e.g., type of industry and activities) and structure (e.g., size, country, corporate organization, subsidiaries) of the company. For example, the industry standard classification of the company and the size may be determined. Size may indicate the company's common mode of recruitment exposure (e.g., social networks, public advertisement, etc.).

The company's Internet presence 1925, may include information regarding the website traffic (e.g., the Alexa® ranking), an assessment of mobile compatibility, presence of analytics tools (e.g. Google analytics), etc.

The company's social network influence 1930 may include a count of the number of “fans” or “followers” on social sites, as well as engagement with the social network community (active discussion in comments and posts). Content sharing activity may also be retrieved, indicating the frequency and quality of the company's social information redistribution.

When analyzing the information 1910, the system may generate a plurality of sub-scores 1940 based upon parameters 1935 and the retrieved information. Sub-scores may include a career site traffic sub-score, a mobile performance/compatibility sub-score, social reach sub-score, and/or a referral potential sub-score (e.g., the sub-scores may be the same or similar as the component scores discussed above in FIG. 16). One will readily recognize additional sub-scores and/or intermediate values that may be used. The sub-scores may be weighted based on a plurality of factors, e.g., their reliability, relevance to an output value under consideration, availability, etc.

Based on the score computation the system may present an output 1915. The output 1915 can include an evaluation of social recruiting potential, custom tips on improving the company's social recruiting potential, and comparative metrics across the industry.

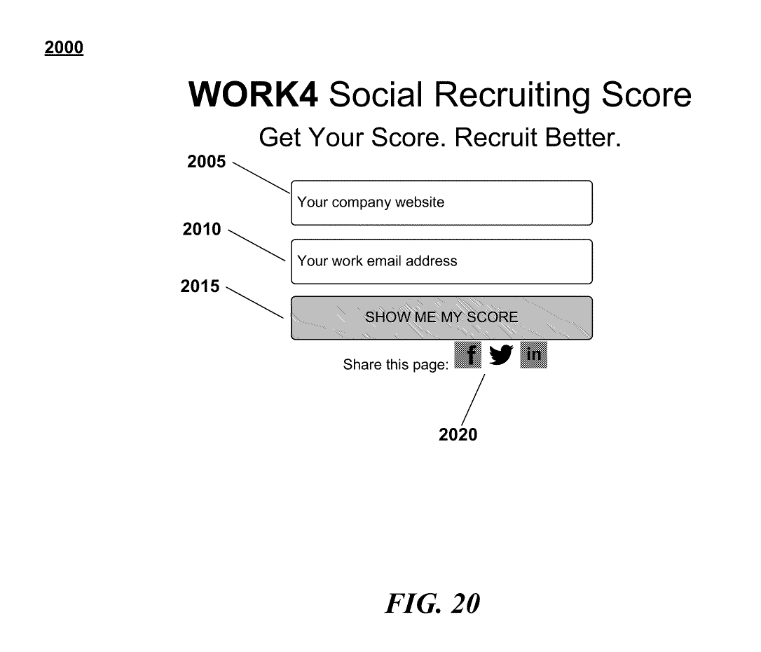

FIG. 20 is a screenshot of a submission portal 2000 for a social recruiting score system as may be presented to a user in some embodiments. A first input 2005 may be provided for receiving a URL or name of the company website to be analyzed. A second input 2010 may be provided for receiving an email address of a user, e.g., to associate the analysis and to provide results. Following submission via input 2015 the analysis may be performed for the website and/or company specified at input 2005. Inputs 2020 may be used to share this page and/or the results of the search with other individuals via one or more social networks.

FIG. 21 is a screenshot of a mobile application acquisition screen 2100 for a social recruiting score system as may be presented to a user in some embodiments. The results 2105 of a mobile compatibility analysis may be presented. Where applicable, software, whitepapers, and/or other resources may be provided in region 2110 for the user to respond to or improve their website based upon the results.

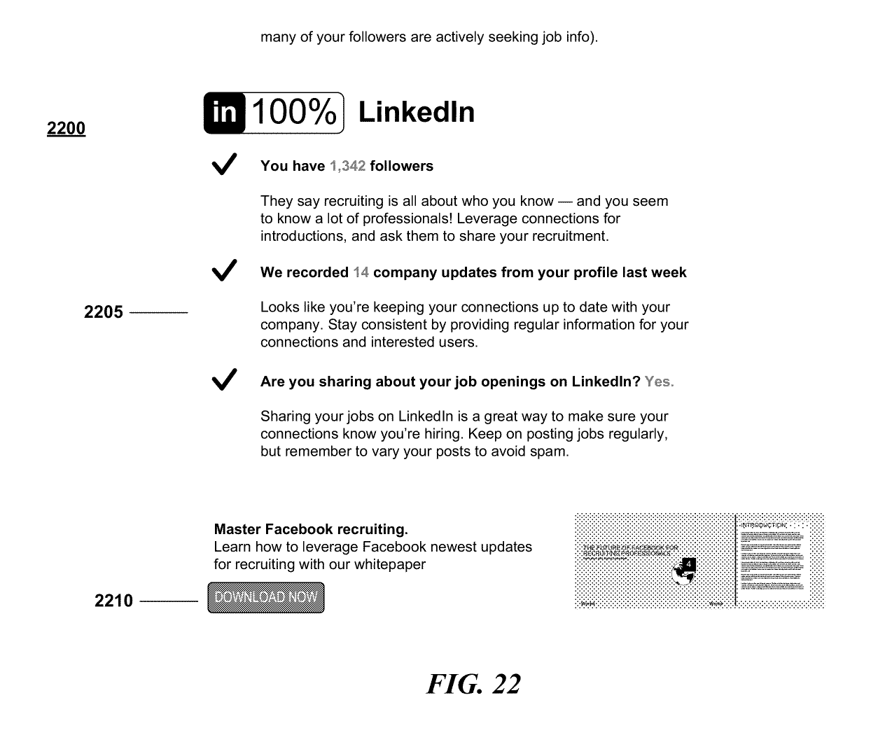

FIG. 22 is a screenshot of a statistical summary screen 2200 of social network data (e.g., LinkedIn® data) for a social recruiting score system as may be presented to a user in some embodiments. An output region 2205 may summarize the results of the analysis, e.g., specifying the number of followers, the number of company updates on the profile within a fixed period, the sharing status on an associated business social networking site, etc. Where applicable, software, whitepapers, and/or other resources may be provided in region 2210 for the user to respond to or improve their website based upon the results.

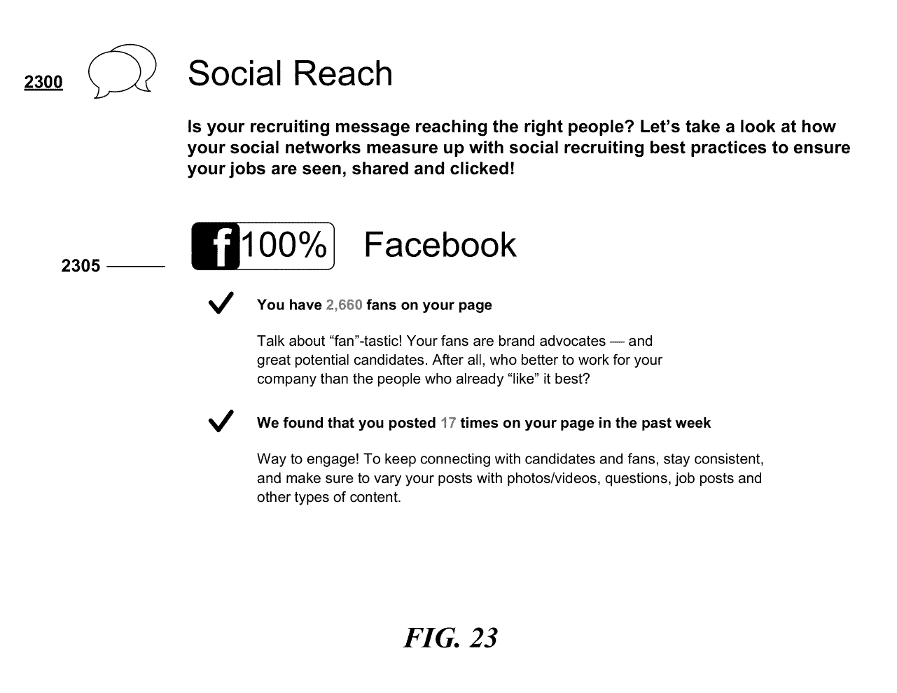

FIG. 23 is a screenshot of a statistical summary screen 2300 of social network data (e.g., Facebook® data) for a social recruiting score system as may be presented to a user in some embodiments. An output region 2305 may summarize the results of the analysis, e.g., specifying the number of fans of the company's social profile page, the number posts upon the page in a fixed interval, etc. Though not depicted in this example, a region may also be provided where software, whitepapers, and/or other resources may be provided for the user to respond to or improve their website based upon the results.

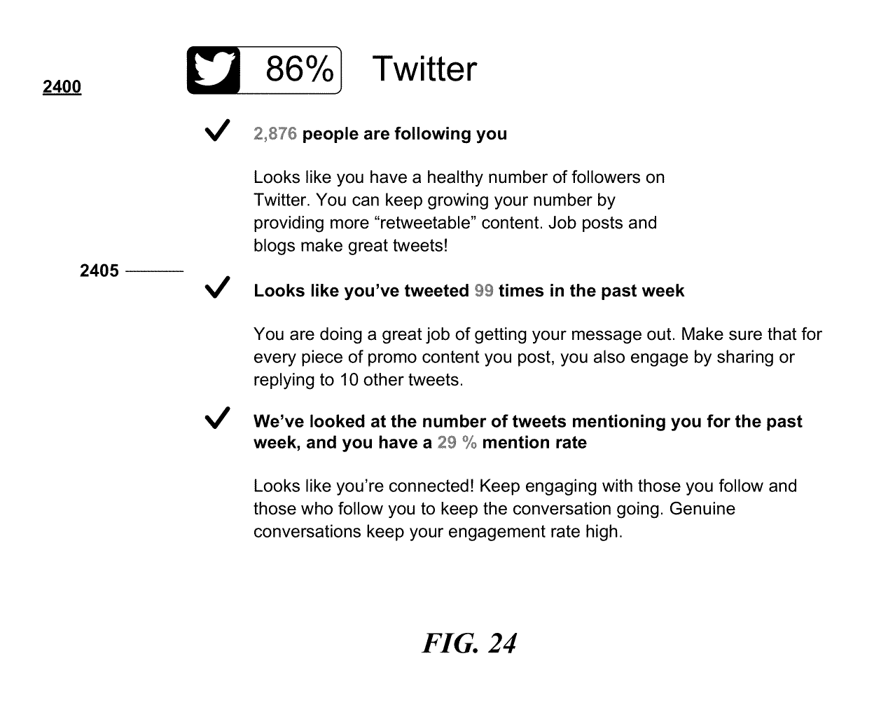

FIG. 24 is a screenshot of a statistical summary screen 2400 of social network messaging data (e.g., Twitter® data) for a social recruiting score system as may be presented to a user in some embodiments. The screen 2400 may include an indication of the number of people following a website on the social network messaging system, a number of times messages have been generated from a source affiliated with the site in a fixed interval, and a number of messages referencing the site in a fixed interval. Though not depicted in this example, a region may also be provided where software, whitepapers, and/or other resources may be provided for the user to respond to or improve their website based upon the results.

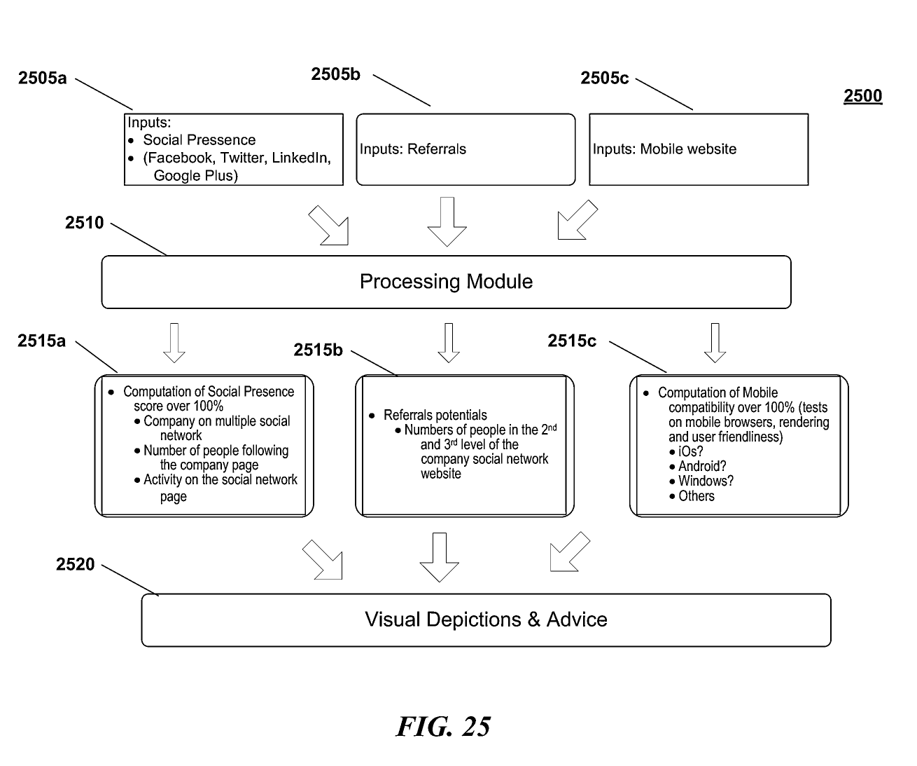

FIG. 25 is a data flow diagram 2500 as may be used in a social recruiting score system in some embodiments (e.g., in conjunction with or in lieu the more general system of FIG. 17). Inputs to a processing module 2510, may include a social network input collection 2505a (e.g., presence on social networks such as Facebook®, Google Plus®, etc.). Inputs to the processing module 2510 may also include referrals information 2505b, e.g., regarding the number of employees associated with the company. Inputs to the processing module 2510 may also include mobile site information 2505c, e.g., the content of a user site accessible by or designed for a mobile device. The processing module 2510 may analyze these inputs, e.g., in the manner described above, and output a plurality of component metrics 2515a-c. The component metrics 2515a-c may include an indication 2515a of the social presence score (e.g., the number of people following the company on multiple social networks, people following the page under analysis or a social network page affiliated with the page under analysis, etc.). The metrics 2515a-c may include an indication 2515b of the referrals potential, e.g., the number of people in the company positioned to reference new people to the site under analysis. The metrics 2515a-c may also include an indication 2515c of the mobile capabilities of the site, e.g., whether the site is accessible and/or properly viewable by particular mobile devices. These metrics 2515a-c may then be packaged and presented as various visual depictions 2520 to the user facilitating user review.

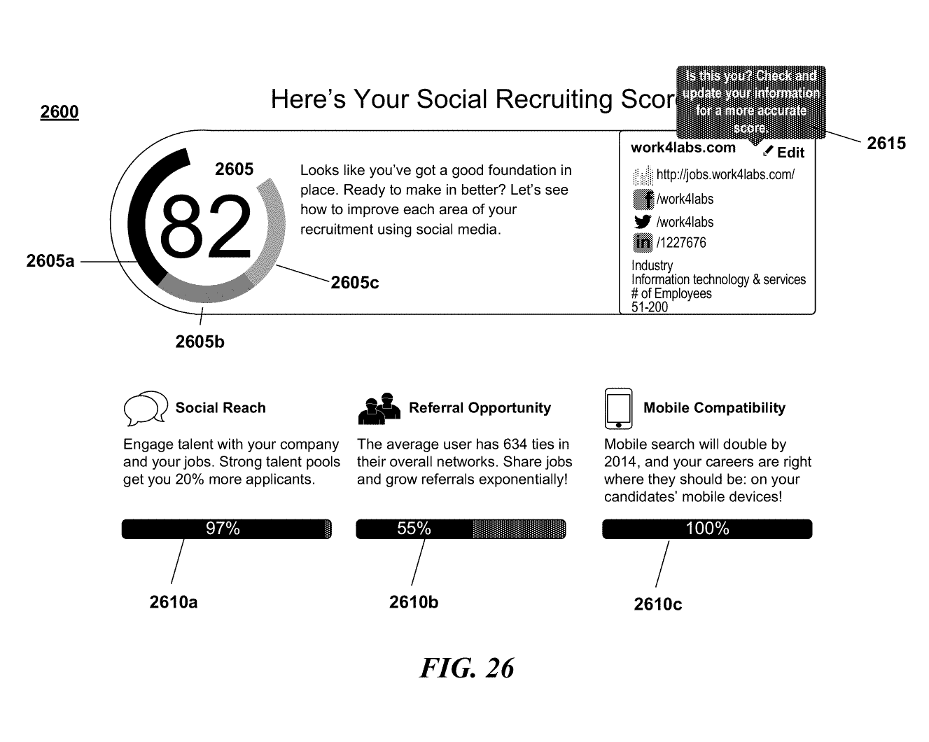

FIG. 26 is a screenshot of a social recruiting score summary screen 2600 for a social recruiting score system as may be presented to a user in some embodiments, e.g., as presented as a visual depiction 2520. A pie chart 2605 may depict an overall score (e.g., “82”) and a pie-chart breakdown of the component score contributions. In this example, a social network score 2605a contributes the most, while a referral score 2605b and mobile compatibility score 2605c contribute slightly less. A social reach summary 2610a, referral opportunity summary 2610b, and mobile compatibility summary 2610c may all be presented. Blurbs, e.g., blurb 2615, may be used to suggest improvements to the user. In this example, blurb 2615, suggests providing additional, or more accurate, information to achieve more complete results.

### Social Job Sharing

In some embodiments, intermediary software may allow “social job sharing” (SJS) between candidates or between candidates and existing employees of various companies. The sharing mechanism may be configurable (e.g., the employee shares only positions most relevant to their networks and/or immediate job position). This software may be especially useful in increasing employee-referred candidates as well as referrals from individuals “in-the-know” for a given social context. Use of the SJS system may be recommended as part of the analysis of a social recruiting score determination described above.

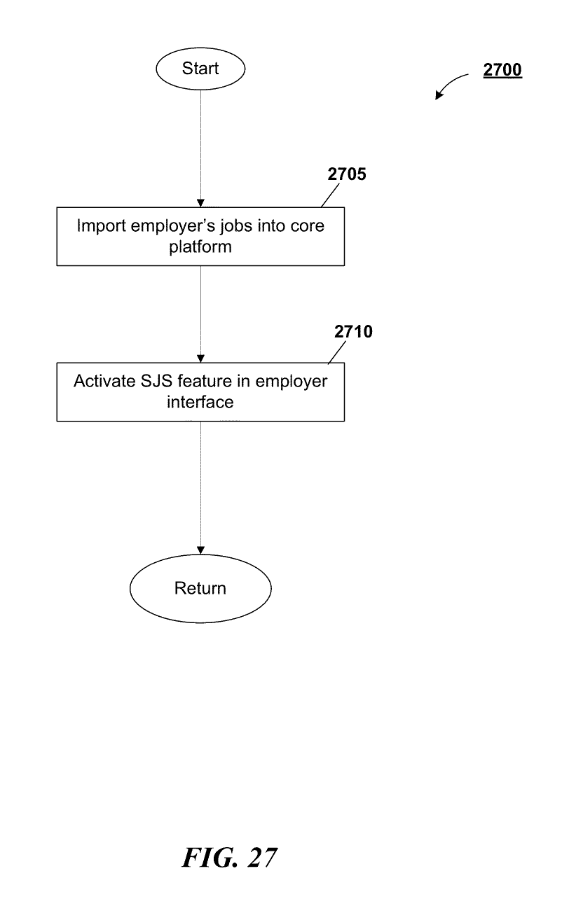

FIG. 27 is a flow diagram depicting various aspects of a system setup for a job system operation 2700 as may be implemented in some embodiments. At block 2705 the system may import an employer's jobs into the platform. For example, the system may make the job information available from a central repository, e.g., using a customized ETL system. In some embodiments, jobs may also be inserted into the system manually. An API or plugins on a social site may then be used to consult the repository as employees or general users use the social site. Once the jobs are imported, at block 2710, the system may activate the SJS feature in the employer interface. In some embodiments, the system may require that at least one job be in the system before proceeding with the activation. Activation of the SJS feature in the employer interface may mean activating API functionality and tools in the employer webpage, e.g., on a social network page.

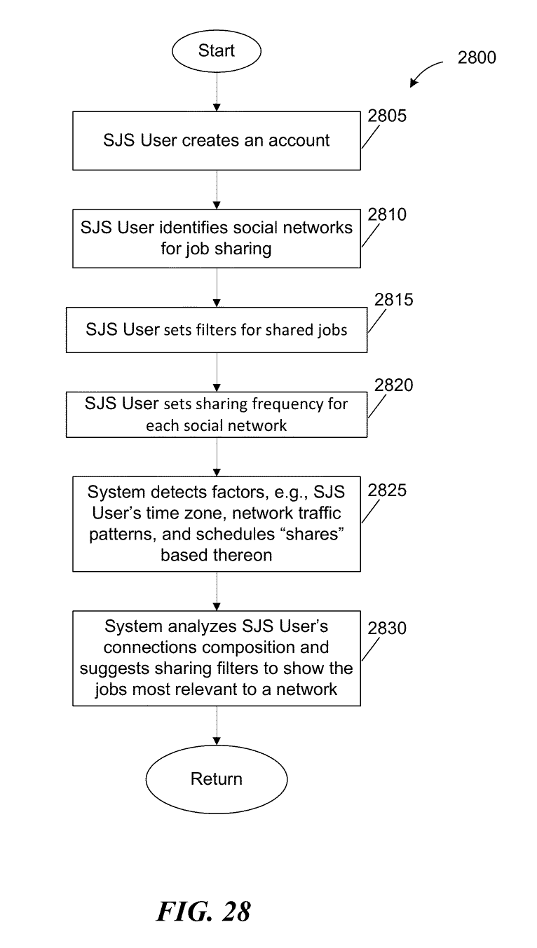

FIG. 28 is a flow diagram depicting various aspects of an SJS user setup for a job system operation as may be implemented in some embodiments. At block 2805 an SJS user (e.g., an employee or a general user, possibly especially knowledgeable about a social network) may create an account with the SJS system, e.g., on the employer's webpage or a third party site operating on behalf of the employer. In some embodiments, this may occur automatically when an employer provides an employee with a social network profile, or when the employee indicates an affiliation with the employer in their social profile.

At block 2810 the SJS user may identify social networks for job sharing. In some embodiments, the system may analyze the user's networks and offer suggestions.

At block 2815 the SJS user may establish filters for the shared jobs.

At block 2820 the SJS user may set a sharing frequency for each social network. The sharing frequency may determine the periodicity with which to circulate new job postings within the social network.

At block 2825 the system may schedule “sharing events” based upon various factors. A scheduled task may run in an asynchronous job queue system. The system may perform a search for new, relevant jobs at each scheduled channel's run that is due for sharing. The system may then update the next posting date (e.g., optimizing for best time of day, etc.). The factors may include, e.g., the sharing frequency, the SJS user's time zone and network traffic patterns.

At block 2830 the system may analyze the SJS user's connections' compositions in each social network, or subset of a social network by connecting to the social network API and exploring the graph of the user's connections once the user grants permission to do so. In some embodiments, the analysis may be based upon group identification techniques. For example, people with the same location, type of jobs, interests, or people being fans of the same page, may be grouped together. The data may be gathered using a social network API. The computation of the analysis may be done on the system servers in some embodiments. A scheduled task on the same job queue system may retrieve activity stats for each post. Another scheduled task may aggregate this activity information per post, channel, user, job, etc., and push this information into an analytics database for further processing.

Based upon the analysis, the system may suggest sharing filters to the SJS user to show jobs most relevant to each network. For example, a software interest group network may receive engineering-related jobs, but not marketing-related jobs. To selectively distribute messages, the system may employ community detection algorithms to detect clusters in the network of the user. These clusters may then be labeled using, e.g., the shared attributes of friends within a community. For instance they system may detect a cluster for previous classmates and another cluster for colleagues. Using the cluster's label (e.g., the school attended) and also possibly the data of the friends belonging to this cluster (e.g., the job titles) the system may then choose one of several categories of jobs that are relevant for this cluster. Choosing a category for a specific cluster (e.g., a specific school) may be done using a hardcoded mapping as well as using the application history for this cluster (e.g., past clicks and past applies of users belonging to this cluster).

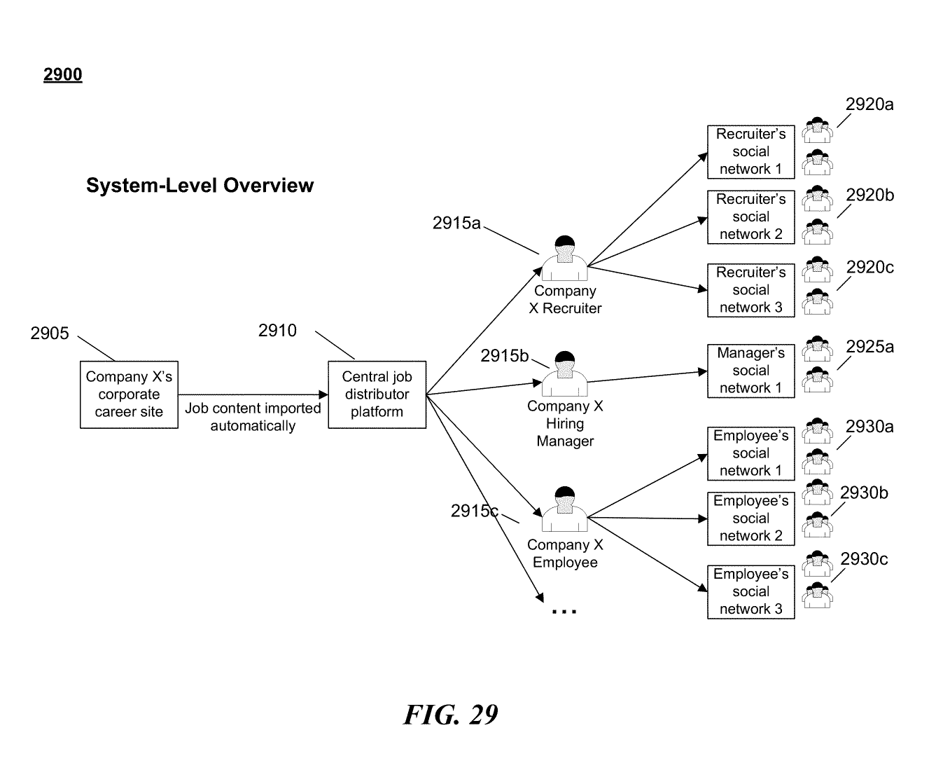

FIG. 29 is a high level block diagram of a social job system 2900 as may be implemented in some embodiments. The system 2900 may import job information automatically (or manually in some embodiments) from a company's corporate career site 2905 into a central job distribution platform 2910. The platform 2910 may then distribute the job information to various potential recruiting entities, such as a recruiter 2915a, hiring manager 2915b, employee 2915c. For example, when a recruiting entity logs into their social profile, a plugin may contact the central platform 2910 and extract relevant job information to populate the recruiting entity's interface, or to send directly to the relevant social network members 2920a-c, 2925a, and 2930a-c. In some embodiments, the distribution of job information occurs surreptitiously without the recruiting entity's direct involvement. For example, central platform 2910 may contact the acquaintances of the employee 2915c based upon information in the employee's social profile, without explicitly contacting the employee 2915c first.

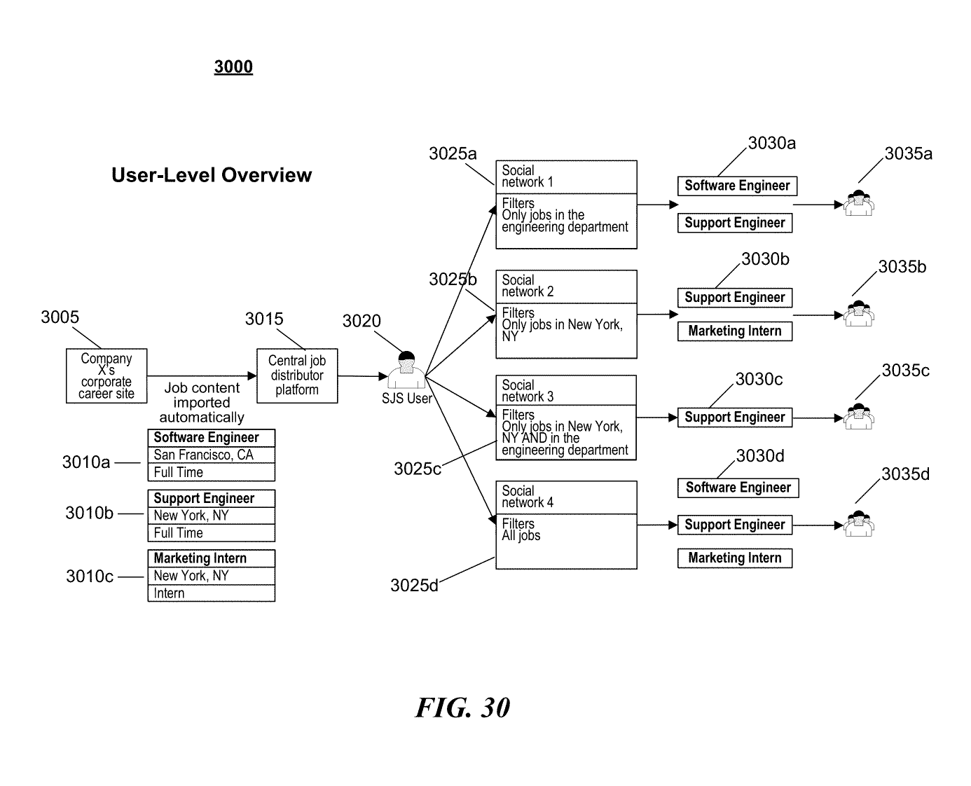

FIG. 30 is a high level block diagram of a user-level overview 3000 of a social job system as may be implemented in some embodiments. Job information 3010a-c may be imported from a career site 3005 to a central platform 3015. The job information in this example includes a software position in San Francisco 3010a, a support engineer position in New York 3010b, and a marketing intern in New York 3010c.

The central platform 3015 may distribute these jobs via the SJS user 3020 (e.g., the employee or knowledgeable user) to various of the SJS user's social networks 3025a-d. Each social network 3025a-d may be associated with a corresponding filter, to limit the number of social network members reached by the job announcement. For example, network 3025a may filter to allow only jobs in the engineering department, network 3025b may filter to allow only jobs in New York, etc. The filters may be determined by the system, specified by an employer, or specified by SJS user 3020. The filters may be based upon the character of the social networks—e.g., the distribution of its members. For example, network 3025c may be directed to engineers in New York. Accordingly, the filters may remove announcements concerning positions outside New York or unrelated to engineering.

Each network 3025a-d need not be a separate social platform (though it may be). Rather, the networks 3025a-d could be subnetworks, or special interest groups, of a larger social network. Networks 3025a-d may also stretch across social platforms (e.g., Facebook®, Twitter®, etc.).

Job announcements 3030a-d may relate information to members 3035a-d of each respective social network based upon the filtering. For example, as depicted, the New York filter 3025b may remove the software job in San Francisco 3010a and distribute only the remaining jobs 3010b, c.

In some embodiments, the platform 3015 detects the user's 3020 time zone (e.g., based on their social profile information) and schedules job sharing events based upon this and traffic patterns of particular networks, so as to increase the number of impressions. For example, the system may generally share during the daytime, avoiding the weekends for the professionally-focused LinkedIn® groups, etc. The system may analyze the composition of connections in a user's network and suggest sharing filters to show the jobs most relevant for that network. For example, if a user has many Facebook® friends with computer science degrees, the platform may suggest a Facebook® filter for software engineering jobs.

### Job Cards

Various embodiments contemplate using a “job cards” construction to display key job information in a visually appealing and readily digestible format. Internet users increasingly rely upon images to quickly scan and identify relevant information. Job cards may provide information more conducive to this style of review. Various embodiments may generate the more digestible format by analyzing an existing job advertisement and rearranging/substituting portions of its content.

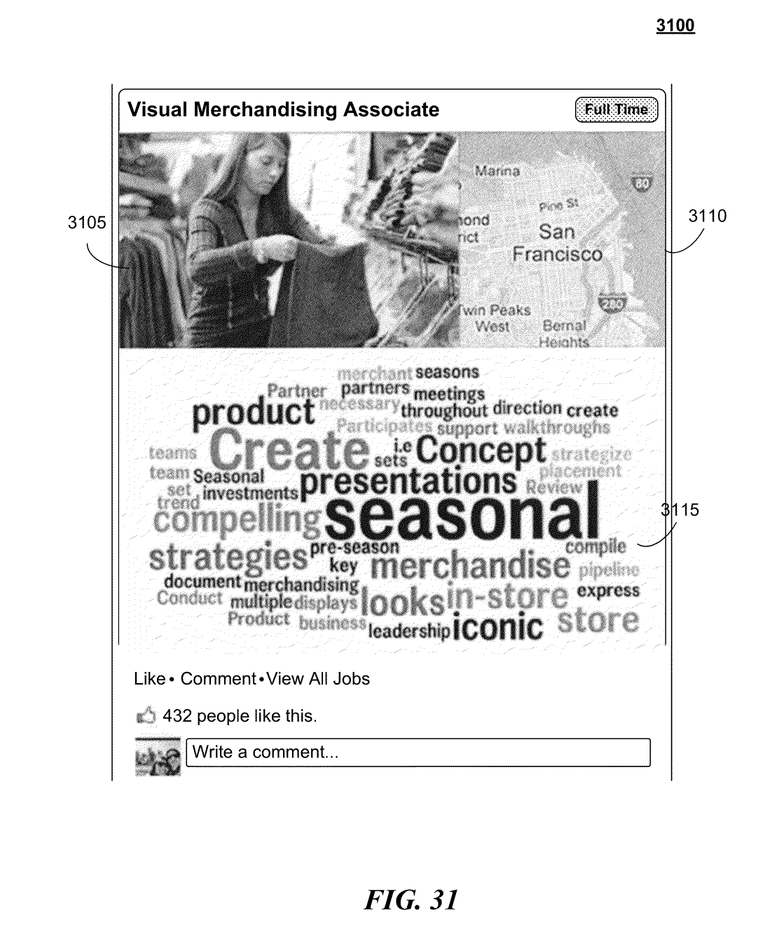

FIG. 31 is an example “job card” 3100 as may be implemented in some embodiments. The job card 3100 may appear on a social networking page, e.g., on a Facebook® page maintained by an employer or upon a portion of an employee's profile page. The job card 3100 may be sent via email in some embodiments, e.g., between social network users. The job card 3100 may comprise a quick image summary region 3105, a geographic summary region 3110, and keyword summary region 3115. Text color, font, and size may be adjusted in the keyword summary region 3115 to reflect the primary features most relevant to the job (e.g., features to attract applicants, as well as to convey the character of the position).

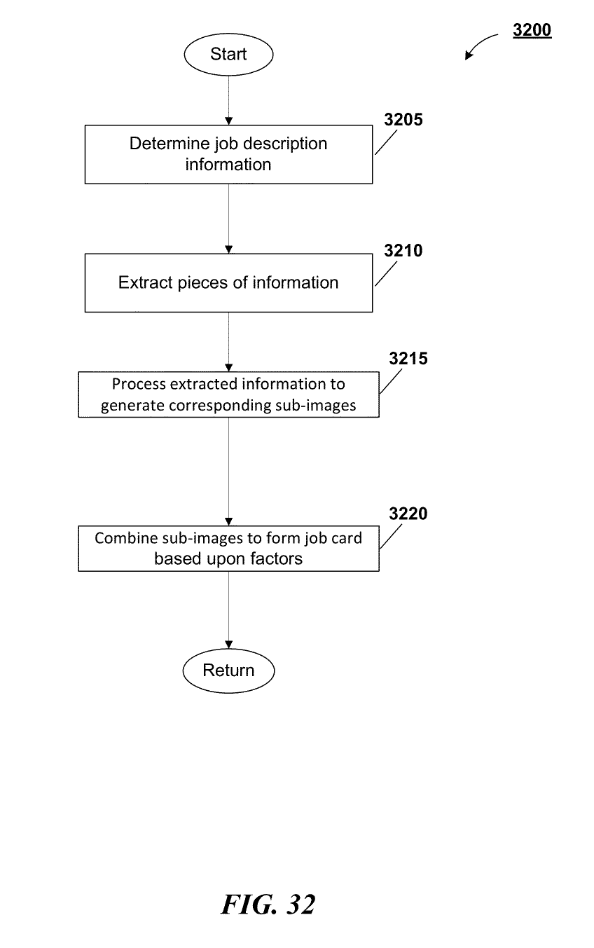

FIG. 32 is a flow diagram depicting certain operations in a job card operation 3200 as may be implemented in some embodiments. The operation 3200 may be used to procedurally generate a job card. At block 3205 the system may determine job description information from the job object already loaded into the system. The job object may be loaded based on manual user input or by an automated ETL system.

At block 3210, the system may extract pieces of information from the job description. Where the description is provided with metadata, e.g., in an XML format, the system may extract the information based upon the metadata. Alternatively, the system may use textual and image analysis when a generic website or form is provided. In some embodiments, when no information is available, default textual elements and a default image may be set.

At block 3215, the system may process the extracted information to generate corresponding sub-images (e.g., quick image summary region 3105). The sub-images may also contain text and may form geographic summary region 3110, and keyword summary region 3115. The sub-images may be procedurally generated, e.g., using a system API which gathers the data and the subimages and outputs the complete image. In some embodiments, the entire system may be template based, and Job Cards may be randomized combinations of sub cards that represent a small piece of information about a job. These small pieces may then be laid out into the full job card according to a system of rules. For example, where the job information indicates, in text, that the job is in Tallahassee, Fla., the system may retrieve a map of that geographic region from a server and crop the relevant portion as geographic summary region 3110.

At block 3220, the system may combine the sub-images to form a job card, e.g., as a composite image as depicted in FIG. 31.

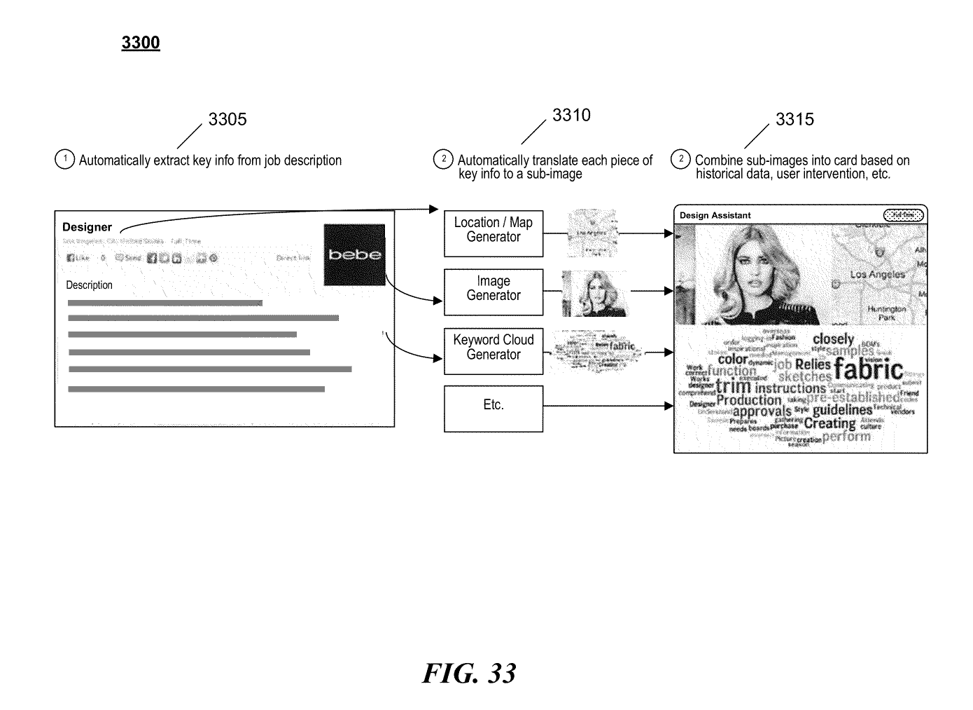

FIG. 33 is a high level block diagram of a user-level overview 3300 in a job card system as may be implemented in some embodiments. At block 3305 the system may automatically extract key information from a job description, such as from a website, a JSON form, an SQL database, etc. At block 3310, the system may translate the information into one or more sub-images and generate additional subimages based thereon. Information may be extracted using a crawler system or using an ETL system. Each sub image may be generated using specific APIs. Maps may be generated using a geographic service such as Bing Maps® API or Google Maps® API. Other images may be added in a modular way to the model. Finally, at block 3315, the sub-images may be combined into a job card. The combination may be performed based upon, e.g., user input, previous job card creations, etc. As indicated, the image generator may generate or select an image with reference to a database outside the initial job description. Similarly, maps of geographic locations may be obtained from an outside server.

### Computer System

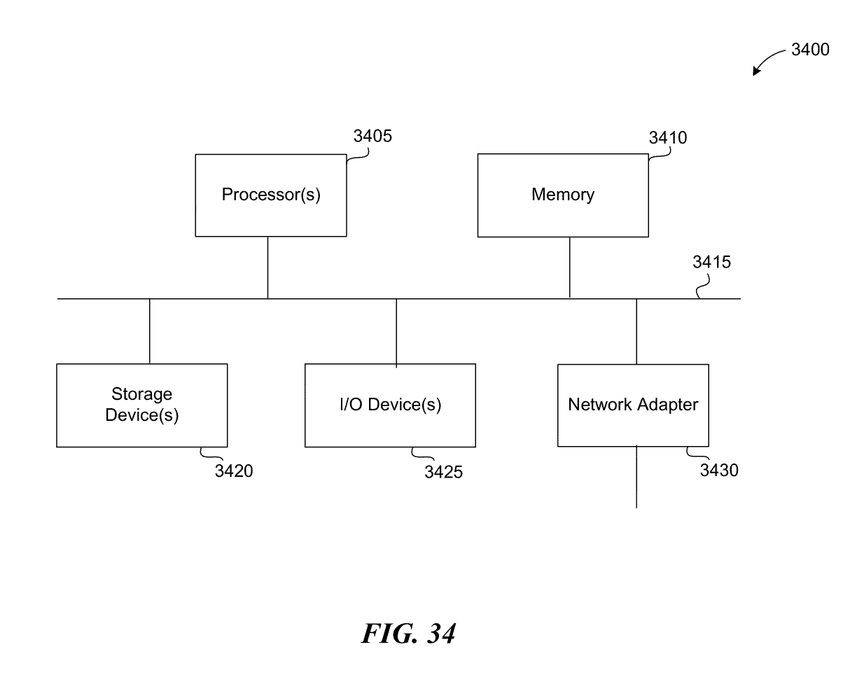

FIG. 34 is a block diagram of a computer system as may be used to implement features of some of the embodiments. The computing system 3400 may include one or more central processing units (“processors”) 3405, memory 3410, input/output devices 3425 (e.g., keyboard and pointing devices, display devices), storage devices 3420 (e.g., disk drives), and network adapters 3430 (e.g., network interfaces) that are connected to an interconnect 3415. The interconnect 3415 is illustrated as an abstraction that represents any one or more separate physical buses, point to point connections, or both connected by appropriate bridges, adapters, or controllers. The interconnect 815, therefore, may include, for example, a system bus, a Peripheral Component Interconnect (PCI) bus or PCI-Express bus, a HyperTransport or industry standard architecture (ISA) bus, a small computer system interface (SCSI) bus, a universal serial bus (USB), IIC (I2C) bus, or an Institute of Electrical and Electronics Engineers (IEEE) standard 1394 bus, also called “Firewire”.

The memory 3410 and storage devices 3420 are computer-readable storage media that may store instructions that implement at least portions of the various embodiments. In addition, the data structures and message structures may be stored or transmitted via a data transmission medium, such as a signal on a communications link. Various communications links may be used, such as the Internet, a local area network, a wide area network, or a point-to-point dial-up connection. Thus, computer readable media can include computer-readable storage media (e.g., “non transitory” media) and computer-readable transmission media.

The instructions stored in memory 3410 can be implemented as software and/or firmware to program the processor(s) 3405 to carry out actions described above. In some embodiments, such software or firmware may be initially provided to the processing system 3400 by downloading it from a remote system through the computing system 3400 (e.g., via network adapter 3430).

The various embodiments introduced herein can be implemented by, for example, programmable circuitry (e.g., one or more microprocessors) programmed with software and/or firmware, or entirely in special-purpose hardwired (non-programmable) circuitry, or in a combination of such forms. Special-purpose hardwired circuitry may be in the form of, for example, one or more ASICs, PLDs, FPGAs, etc.

### Remarks

The above description and drawings are illustrative and are not to be construed as limiting. Numerous specific details are described to provide a thorough understanding of the disclosure. However, in certain instances, well-known details are not described in order to avoid obscuring the description. Further, various modifications may be made without deviating from the scope of the embodiments. Accordingly, the embodiments are not limited except as by the appended claims.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that the same thing can be said in more than one way. One will recognize that “memory” is one form of a “storage” and that the terms may on occasion be used interchangeably.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any term discussed herein is illustrative only, and is not intended to further limit the scope and meaning of the disclosure or of any exemplified term. Likewise, the disclosure is not limited to various embodiments given in this specification.

Without intent to further limit the scope of the disclosure, examples of instruments, apparatus, methods and their related results according to the embodiments of the present disclosure are given above. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

What is claimed is:

1. A computer-implemented method for distributing job information comprising:
receiving a plurality of job descriptions;
determining a subset of the plurality of job descriptions by applying at least one filter, the at least one filter associated with at least one social network associated with a user; and
distributing the subset of the plurality of job descriptions to a subset of members of the at least one social network.

2. The computer-implemented method of claim 1, wherein the filter is directed to a technical specialty or to a geographic region.

3. The computer-implemented method of claim 1, further comprising generating the at least one filter based upon the social profiles of the subset of members of the at least one social network.

4. The computer-implemented method of claim 3, wherein generating the at least one filter based upon the social profiles of the subset of members of the at least one social network comprises selecting members of the user's social network based upon the occupation information in their social profile.

5. The computer-implemented method of claim 1, wherein the job descriptions comprise a geographic region, salary information, and position description information.

6. The computer-implemented method of claim 1, further comprising determining the subset of members of the at least one social network based on a category associated with the subset of members.

7. The computer-implemented method of claim 6, further comprising determining the category based on one or more of job applications submitted by the subset of members, webpages visited by the subset of members, or social profile information of the subset of members.

8. The computer-implemented method of claim 1, wherein distributing the subset of the plurality of job descriptions to a subset of members of the at least one social network comprises:
determining a timezone associated with the user;
determining a distribution time based upon historical network traffic patterns; and
distributing the subset of the plurality of job descriptions based on the distribution time.

9. A non-transitory computer-readable medium comprising instructions configured to cause one or more computer systems to perform a method comprising:
receiving a plurality of job descriptions;
determining a subset of the plurality of job descriptions by applying at least one filter, the at least one filter associated with at least one social network associated with a user; and
distributing the subset of the plurality of job descriptions to a subset of members of the at least one social network.

10. The non-transitory computer-readable medium of claim 9, wherein the filter is directed to a technical specialty or to a geographic region.

11. The non-transitory computer-readable medium of claim 9, wherein the job descriptions comprise a geographic region, salary information, and position description information.

12. The non-transitory computer-readable medium of claim 9, further comprising determining the subset of members of the at least one social network based on a category associated with the subset of members.

13. The non-transitory computer-readable medium of claim 12, further comprising determining the category based on one or more of job applications submitted by the subset of members, webpages visited by the subset of members, or social profile information of the subset of members.

14. The non-transitory computer-readable medium of claim 9, wherein distributing the subset of the plurality of job descriptions to a subset of members of the at least one social network comprises:
determining a timezone associated with the user;
determining a distribution time based upon historical network traffic patterns; and
distributing the subset of the plurality of job descriptions based on the distribution time.

15. A computer system comprising:
at least one processor;
at least one memory comprising instructions configured to cause the at least one processor to perform a method comprising:
receiving a plurality of job descriptions;
determining a subset of the plurality of job descriptions by applying at least one filter, the at least one filter associated with at least one social network associated with a user; and
distributing the subset of the plurality of job descriptions to a subset of members of the at least one social network.

16. The computer system of claim 15, wherein the filter is directed to a technical specialty or to a geographic region.

17. The computer system of claim 15, wherein the job descriptions comprise a geographic region, salary information, and position description information.

18. The computer system of claim 15, further comprising determining the subset of members of the at least one social network based on a category associated with the subset of members.

19. The computer system of claim 18, further comprising determining the category based on one or more of job applications submitted by the subset of members, webpages visited by the subset of members, or social profile information of the subset of members.

20. The computer system of claim 15, wherein distributing the subset of the plurality of job descriptions to a subset of members of the at least one social network comprises:
determining a timezone associated with the user;
determining a distribution time based upon historical network traffic patterns; and
distributing the subset of the plurality of job descriptions based upon the distribution time.
